(19) United States
(12) Patent Application Publication
(10) Pub. No.: US 2015/0286978 A1
(43) Pub. Date: Oct. 8, 2015

(54) SYSTEM AND METHOD FOR PERFORMANCE MEASUREMENT AND CONTROL

(71) Applicant: STEREOLOGIC INC., Toronto (CA)

(72) Inventors: Sofia PASSOVA, Richmond Hill (CA); Alexander LADIZGINSKY, Toronto (CA); Stanislav PASSOV, Richmond Hill (CA)

(21) Appl. No.: 14/679,425

(22) Filed: Apr. 6, 2015

Related U.S. Application Data
(60) Provisional application No. 61/975,062, filed on Apr. 4, 2014.

(51) Int. Cl. G06Q 10/06

(52) U.S. Cl. CPC G06Q 10/06393; G06Q 10/067

(57) ABSTRACT

A system and method for performance measurement where the method includes: determining at least a first significant point and a second significant point based on baseline patterns of a business operation; detecting at least one combination of parameters characterizing the at least two significant points; determining recognized patterns based on the first and second significant points; measuring a time between a first significant point and a second significant point of a recognized pattern; and generating at least one performance measurement based on the measured time, and the system is configured to perform the method via a computer in an automated fashion.

### REFERENCE TO RELATED APPLICATION(S)

This application claims the benefit of provisional application No. 61/975,062, filed Apr. 4, 2014, the content of which is hereby incorporated herein by reference.

### BACKGROUND

Conventional methods for performance measurement can be generally classified in two groups:

Performance measurement embedded in Business Process Management Systems

Desktop Analytics Tools

The implementation of the first approach is often very expensive as it generally requires overall IT infrastructure changes. Only after that change the performance data can be gathered and analyzed. Further, this class of solutions may be restricted by the platform itself, not covering such typical employee activities as sending/receiving Emails, web browsing or applications, editing documents, working with spreadsheets, reviewing documents or the like.

The second approach generally requires installation of proprietary software on each employee workstation. This effort may be expensive and may be unmanageable for a large enterprise with many employees. Further, the organization's performance or security requirements may prevent use of desktop capture tools.

As such, there is a need for improved systems and methods to measure performance and provide diagnostics regarding the performance.

### SUMMARY

Embodiments of the system and method described herein are intended to overcome at least one of the issues with conventional systems.

In one aspect herein, there is provided a method for performance measurement including: determining at least a first significant point and a second significant point based on baseline patterns of a business operation; detecting at least one combination of parameters characterizing the at least two significant points; determining recognized patterns based on the first and second significant points; measuring a time between a first significant point and a second significant point of a recognized pattern; and generating at least one performance measurement based on the measured time.

In a particular case, the method may include: monitoring a plurality of users performing the business operation; determining if the first significant point and the second signification point of the recognized pattern correspond to the business operation for each user of the plurality of users; and if the first significant point and the second significant point correspond, measuring each user's performance to generate the at least one performance measurement.

In another particular case, the at least one parameter may include screen layout, data on a screen, user events, images, and related elements.

In another particular case, a plurality of parameters may be detected to characterize the at least two significant points.

In yet another particular case, the at least one performance measurement may include: number of processes completed by a user; average time per process, user time per process and deviation of user performance.

In still yet another particular case, the monitoring of the plurality of users performing business operations may be monitored in real time.

In still yet another particular case, the method may further include: storing the monitoring of the each of the plurality of users performing business operations as a stored performance; and performing analysis related to the at least one performance measurement based on the stored performance.

In yet another particular case, the method may further include: providing suggested changes to the business operations based on the at least one performance measurement.

In yet another particular case, the method may further include: analysis of delays and detection of actual activities causing them based on comparison with the baseline pattern activities and providing suggested changes to the business operations based on the at least one performance measurement.

According to another aspect herein, there is provided a system for performance measurement including: a significant point module configured to determine at least a first significant point and a second significant point based on baseline patterns; a parameter module configured to detect parameters characterizing the at least two significant points; a parameter pattern module configured to determine recognized patterns based on the key parameters; a timer module configured to measure a time between the first significant point and the second significant point of a recognized pattern; and a reporting module configured to generate a performance measurement based on the measured time.

### BRIEF DESCRIPTION OF THE DRAWINGS

Embodiments of the system and method herein will now be described, by way of example only, with reference to the attached drawings, in which:

FIG. 1 illustrates a system (an automated computer system) for employee performance measurement according to an embodiment herein.

FIG. 2 shows a screen shot for the Definition of the Baseline Patterns.

FIG. 3 shows a screen shot for the Definitions of Key Parameters for a Significant Point (using the Recognition Rule Mechanism).

FIG. 4 shows a screen shot for the Estimation of Rule Precision (for debugging of Rules and Key Parameters).

FIG. 5 shows a screen shot for the Defining Significant points for time measurements.

FIG. 6 shows a screen shot for the Selection of Employee whose performance will be analyzed.

FIG. 7 shows a screen shot for the Employee Performance Measurement and Control Report (generated automatically).

FIG. 8 shows an Overall Scheme for an embodiment of the system and method herein.

FIGS. 9 to 47 illustrate an embodiment of a system and method for performance measurement and diagnostics.

### DETAILED DESCRIPTION

In the description, various embodiments will be described. For purposes of explanation, specific configurations and details are set forth in order to provide a thorough understanding of the embodiments. However, it will also be apparent to one skilled in the art that the present system and method may be practiced without the specific details. Furthermore, well-known features may be omitted or simplified in order not to obscure the embodiment being described.

Embodiments of the proposed system and method for performance measurement and diagnostics are intended to provide non-intrusive employee performance measurement and diagnostics. An intended advantage of the proposed method is the ability to measure performance of employees utilizing existing IT environment and business applications (the current IT infrastructure and business architecture) without any infrastructure change. This approach also does not require installation on each employee's desktop, since, for example, the embodiments can utilize agents running in standard Web Browsers and store the data on a Web server.

Embodiments of the proposed method are intended to include:
1. Non-intrusive monitoring of a plurality of employees performing business operations and recording a large amount of data related to their flows/activities (sometimes called “Big Data”).
2. Selection and definition of Baseline Patterns, which will be used for recognition of meaningful processes in the “Big Data”
3. Selection of Significant Points (activities), which are characteristic for the considered Baseline Pattern.
4. Detection of one or more, or combinations, of Key Parameters characterizing the Significant Points obtained non-intrusively, such as:
   Screen layout;
   Data on the screen and its attributes;
   User events (actions performed by the user);
   Images and their elements; and the like
5. Recognition of required Baseline Pattern(s) in the “Big Data” via recognition of Significant Points associated with this Baseline Pattern(s)
6. Each Significant Point can be recognized through, for example, the combination of Key Parameters detected in the item 4. For quicker practical implementation only a subset of Key Parameters can be used.
7. A special mechanism of rules (Recognition Rule Mechanism) allows selection of an optimal set of Key Parameters for detection of required Control Points in the “Big Data”. The selection can be accomplished by iterative process of choosing parameters and analyzing their recognition power (level of recognition).
8. Time is measured for the first and last Significant Points of each recognized pattern and is considered as the Process Start Time and Process End Time.

In the result, this method is intended to allow for the automated generation of performance measurement and employee control data: the number of processes completed by each employee, time per process for each employee, deviation of employee performance, and the like.

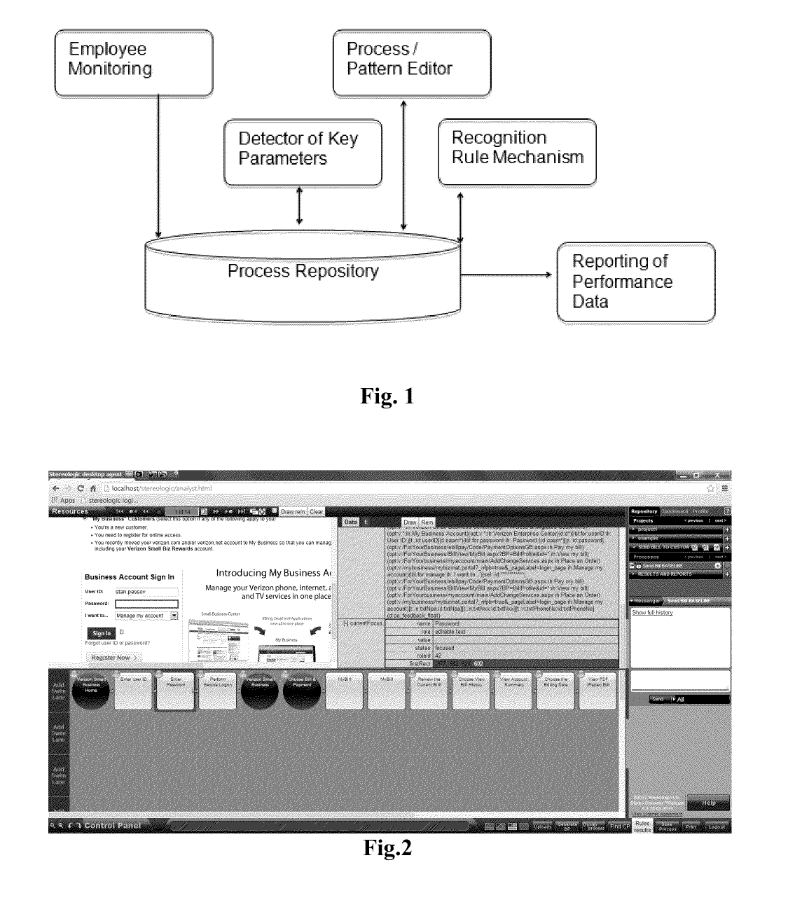

Embodiments of the proposed method can be implemented in an automated computer system as illustrated by a system embodiment in FIG. 1.

FIG. 2 shows a screen shot for the Definition of the Baseline Patterns.

FIG. 3 shows a screen shot for the Definitions of Key Parameters for a Significant Point (using the Recognition Rule Mechanism).

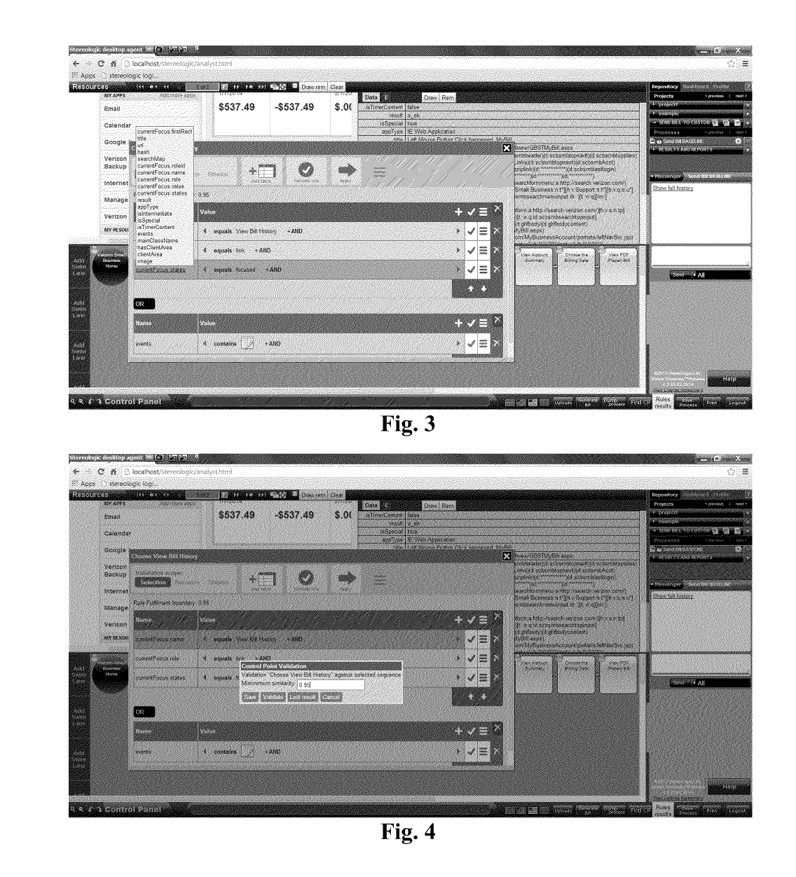

FIG. 4 shows a screen shot for the Estimation of Rule Precision (for debugging of Rules and Key Parameters).

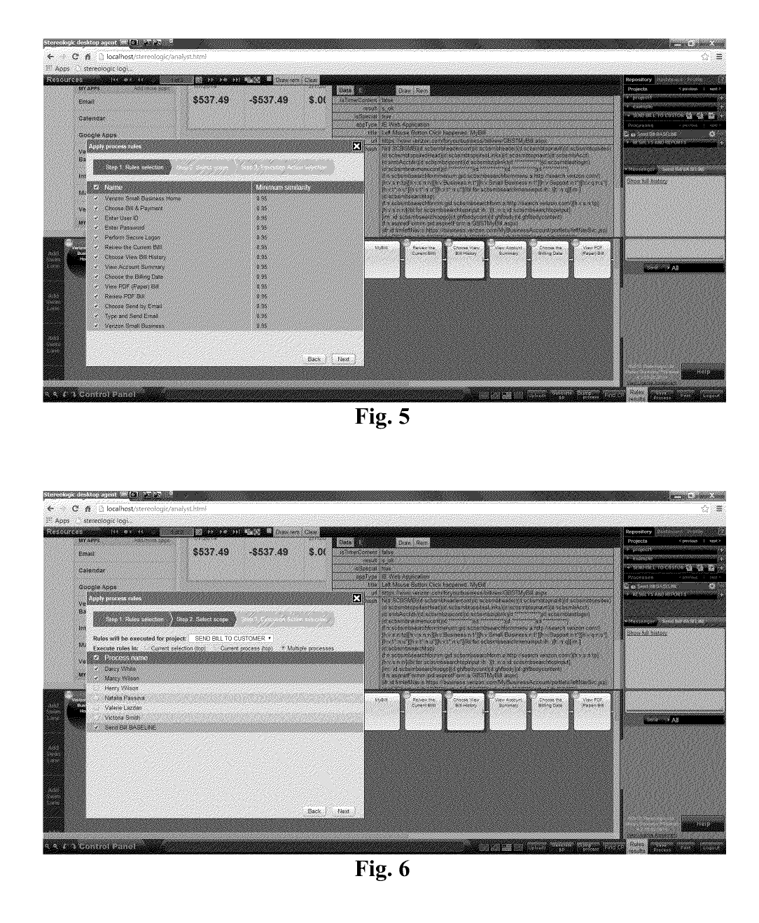

FIG. 5 shows a screen shot for the Defining Significant points for time measurements.

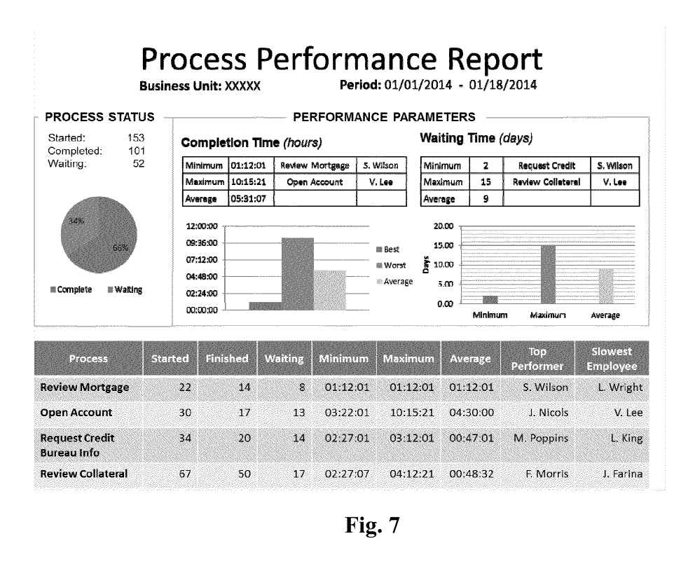

FIG. 6 shows a screen shot for the Selection of Employee whose performance will be analyzed.

FIG. 7 shows a screen shot for the Employee Performance Measurement and Control Report (generated automatically).

The embodiments of the system and method detailed herein may be implemented by a computer or may be stored on a computer readable medium. The computer may have a processor configured to execute the instructions provided by the modules and components of the system or provided by instructions stored on the computer readable medium.

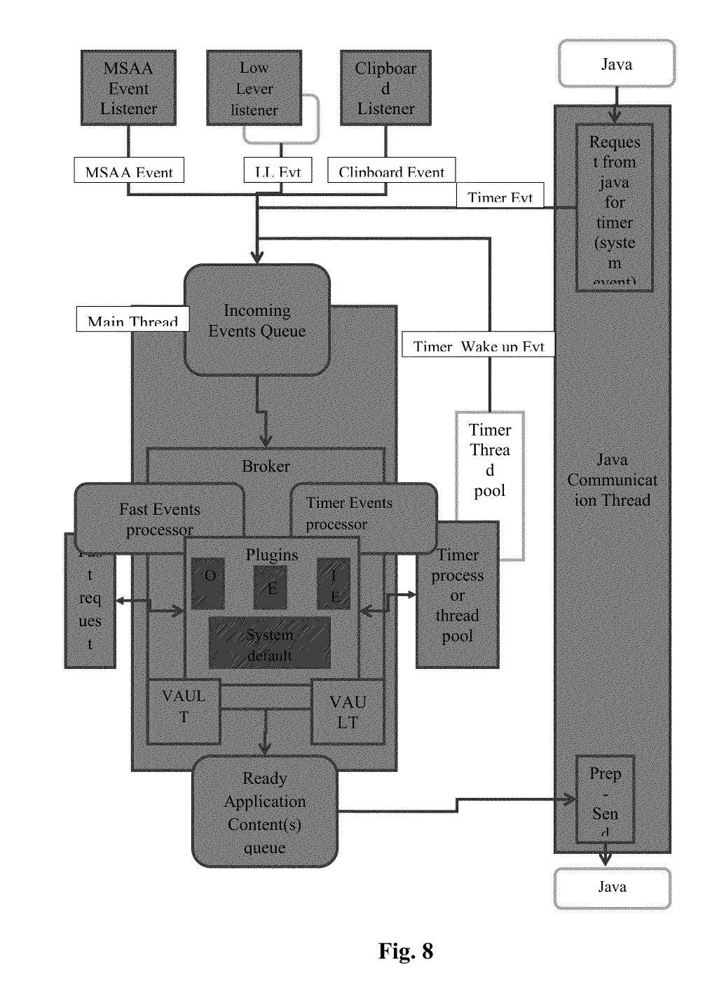

FIG. 8 shows an Overall Scheme for an embodiment of the system and method herein.

In one embodiment, the method proceeds as follows:
1. Record non-intrusively plurality of employee process as a sequence of Key Parameters: Screen images, User events and other visual attributes (screen size, etc.); and the corresponding time
2. Define of Baseline Process as a composition of flow of activities and decision points using, for example, the methods described in US Patent Publication No. 20100174583, “Systems and methods for business process modeling”, to Passova et al; US Patent Publication No. 20130179365, “Systems and methods of rapid business discovery and transformation of business processes”, to Passova et al; or as generally described hereinafter.
3. Consider as a pattern a required fragment of the Baseline Process, such as: a fragment between two decision points, between start and end of the process, etc.
4. Consider the first activity of the selected pattern as the first Significant Point.
5. For the first Significant Point (activity) select the most descriptive combination of Key Parameters captured by the recording (see 1. above) during the time-window of this activity.
6. Define the descriptive combination of Key Parameters as a Recognition Rule for the Significant Point using Boolean functions and other operations.
7. Apply the Recognition Rule (using the Recognition Rule Mechanism) to the plurality of employee processes (“Big Data”) recorded in the 1. above to detect all occurrences of the first Significant Point (the beginning of the required pattern).
8. Similarly to 4. above, consider the last activity of the selected pattern as the second Significant Point.
9. Detect occurrences of the second Significant Point (the end of the required pattern) similarly to steps 5-7.
10. Measure the time measuring a time between a first Significant Point and a second Significant Point of the recognized patterns;
11. Steps 1-10 can be repeated for any chosen pattern.

An intended advantage of the proposed method is that not only does it not require intrusive monitoring (with physical capture of system parameters), but also measurements are done in the context of known business processes, which allows performing diagnostics of process delays and other issues.

As an example, if some recognized pattern in the plurality of recorded processes (performed by a particular employee) takes more time compared to other similar recognized patterns (performed by other employees), the method allows for the diagnosis and localization of the problem:
1. Required activities of the delayed fragment are known based on the baseline pattern
2. The actual activities were recorded during step 1. above.
3. Analysis of the deviating activities and the time spent on them allows diagnosing and localizing the reason of delays.

The following information relates to details of example embodiments of the system and method herein for the purpose of illustrating the structure processes and functionality of embodiments of the system and method.

Terminology
1. Event Originator Window—HWND of the window that was designator as the recipient or owner of the event. Examples:
2. WindowOfInterest—HWND of the window that has a non null (and not empty) title and is the closest ancestor or owner of the Event. (Could be the Event Originator Window itself). In case none of the ancestors have titles—need to look up . . . .
3. ParentOfInterest—HWND of the window that is the farthest ancestor or Owner of the Event Originator Window that has non null title.
4. ChainOfInterest—List of ancestral chain of the originator windows.

Vault Contents Schema
1. Last Succesful timer event for each WindowOfInterest/ChainOfInterest (key of 2 items-map)
2. Last Succesful fast event for each WindowOfInterest/ChainOfInterest(key of 2 items map)
3. Last incomplete AppContent (as result of not important events)
4. Copy of Last AppContent sent to Time process thread. (Identifiable by something that would be required as identifier for wakeup event)
5. Copy of AppContent currently in Blockable Fast Event thread. Required in case the time identified has passed and nothing is returned.
6. Special map for storing events app contents or other objects required for complex events processing. Events that require more than one simple event and communication between different plugins (app contents) overtime. (Or same plugin overtime
7. Cleaner for special map(6)

Incoming Event Common Information
1. Event window (Window of Interest)
2. Event chain Window (either window of Interest or upper window chain with text) if different from 1.
3. Event originator window (optional if exists)
4. Common information about 1,2,3 (titles, window types, sizes, class)
5. For 1 (WindowOfInterest) GetGUIThreadInfo and all the common information for all present windows.
6. Processed Event text (Depends on the listener)
7. Reserved Identifier
8. Start Time of Event.

MSAA Additional Event Information
1. Object Id
2. Child Id
3. Event Type
4. Role (text)
5. Name (text)
6. Value (optional depends on event)
7. State (Text)
8. Reserved for other information

Lower Level Additional Information
1. AsynchKeyState
2. Cursor place
3. Cursor Type
4. Screenshot (optional really optional)
5. Clipboard additional Information

Additional Things to Writeout
1. Schemas for Broker function
2. Settings for Plugins and global turn on turn off settings
3. ApplicationContent (Plugin API)
4. Broker API
5. Transfer to Java Algorithm
6. Common Rules for filling out dTitle dUrl dHash and timing

BrokerAPI

ApplicationContentFactory getFactory( )

Screenshot makeScreenshot(Rect rct);

Screenshot makeScreenshot(hwnd window, Boolean clientAreaOnly, Boolean takeFromInternalPool)

ApplicationContentFactory methods

ApplicationContent getNewPlugin(Hwnd hwnd, Settings settings)

ApplicationContent getNewPlugin(Hwnd winOfInterest, Hwnd parentOfInterest, Settings settings)

ApplicationContent getNewPlugin(IncomingEvent evt, Settings settings, Hwnd window);

Synchronizing Screen and User Events

Assumptions
1. All variables and events including image contain more or less accurate timing
2. IdString is an accurate variable
3. There is a postProcessing Module that is able to look at the recording as whole, and build missing and state variables.
4. Work on the assumption where false positive (i.e rule found something that it should not have found) is better than false negative (i.e rule did not find something it should have found)
5. Image in every resource is guaranteed
6. Each variable can be checked as to whether it was filled or not. (is Ok)

Goals
1. To further mitigate asynch. situation where some variables, acquired in a different sequence or at different times, in comparison to “ethalon” recording, therefore not allowing to find a control point via straightforward rule application.
2. To mitigate asynch situations where variables such as image are acquired too late or too early in the process.

Some Definitions
1. Dependable variable—variable upon which some other variables or their composite parts will depend. There may only be one dependable variable—Image. Example: ClickArea or FocusArea depend on image.
2. Same IdString Sequence. —Going through the recording—all resources with same idstring in order of their appearance. Please note that they may be separated by other resources with different IdString.

Rough Solution Steps.
1. Using IdString and PostProcessing Module initialize missing state variables, (CurrentFocus, hash, url). This way each resource will contain all variable sets. Special care should be given to timing of initiated variables. (i.e prior to any variables of real resource). Some of that work can be achieved via current smoothing module on C++ side.
2. Within same IdString sequence, put all variables and events in chronological faction.
3. Run a growing and shrinking window through the same IdString sequence variables, making sure that there is always two images (two resources involved). Run a rule on window contents (treat two same variables as or) Resources whose variables participate in winning rule above degree of fulfillment will be considered part of ctrl point.

### Examples

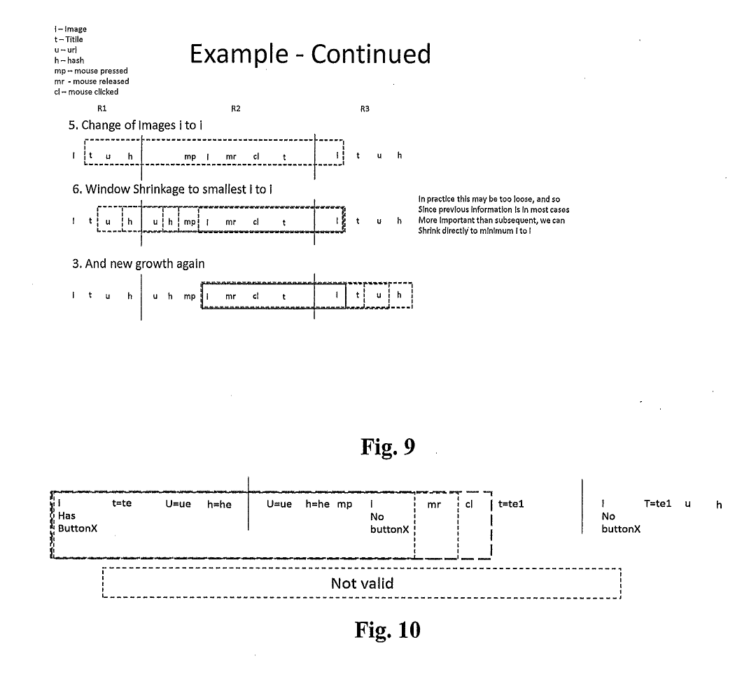

### FIG. 9 Illustrates and Example Operation

### Specific Rule Application Example

Rule is created from the following ethalon

t=te AND u=ue AND h=he AND events contain {cl}; AND cl.clickarea matches <buttonX>.

In this case in the ethalon recording buttonX image was acquired such that upon mouse pressed it had not changed yet. However in general this button changes appearance significantly after mouse press.

Title was also captured before it changed from to to te1, following the click.

* In real recording while all the other variables held there are changes compared to ethalon. Green shows rule fulfillment.

FIG. 10 Handling of Dependent Derived Variables—Definitions

Derived variables—created during smoothing from events and propagated into subsequent resources with same IdString. (Timing information is preserved and equal to event that created the Variable in the first place)

Dependent derived variable—Derived Variable that (in whole or part) is dependent upon image(s) around its creation place.

Handling of Dependent Derived Variables—Existing Example

Currently only one Dependent Derived Variable exists (and may show up). It is called CurrentFocus. This is a composite variable that is created via smoothing C++ function. Aside from timing/isOk information it consists of the following visible subitems

Name (string)

Role(string)

RoleId(Integer)

States(string)

Value (String)

FirstRect—May contain rectangle coordinates of the focused area. This is the dependent part as it depends on the image(s) around the focus event that was the origin of the variable

Handling of Dependent Derived Variables—Challenge with Dependent Part

As with normal flow of events, there could be synchronization problems between part that depends on the image(s) and the original event that created the variable. Moreover the variable then propagates into subsequent resources, and it's origin must be tracked to the original event or resource.

Therefore a rule dependent on CurrentFocus variable (specifically it's dependent part may encounter double challenges.

Ex: CurrentFocus.name=“Submit” and CurrentFocus.firstRect matches [Button1]

Handling of Dependent Derived Variable—Solution.

Each resource has and internal (non visible reference guid variable). CurrentFocus variable references the originating resource via this guid and has precise timing of the originating event. Therefore image(s) on which CurrentFocus.firstRect depends can be traced.

Once traced it may be applied to similar windows (although in some cases it may be more restrictive) and get images upon which firstRect is dependent.

Once dependable images are found, firstRect coordinates are applied to each of them and cutOutResults become possible values of CurrentFocus.firstRect that will be evaluated in the rule via OR.

Same IdString constraint for window applies here as well.

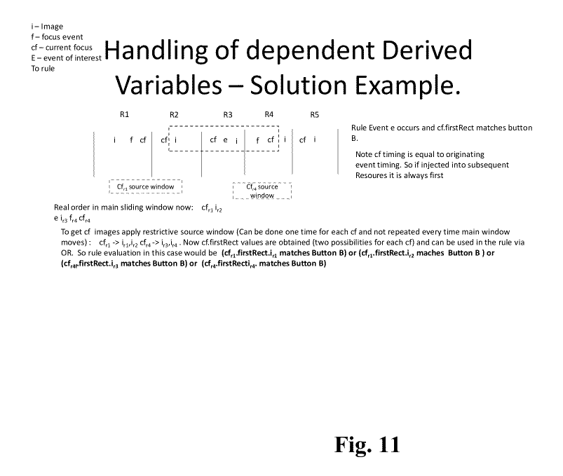

Handling of Dependent Derived Variables—Solution Example in FIG. 11.

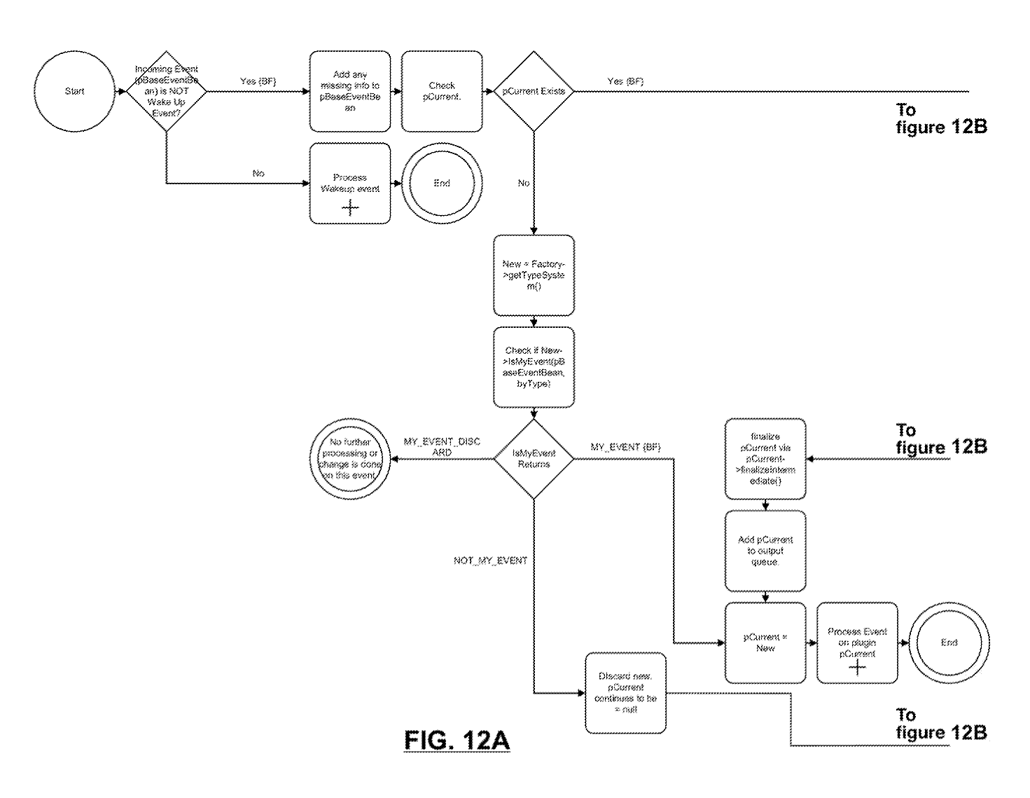

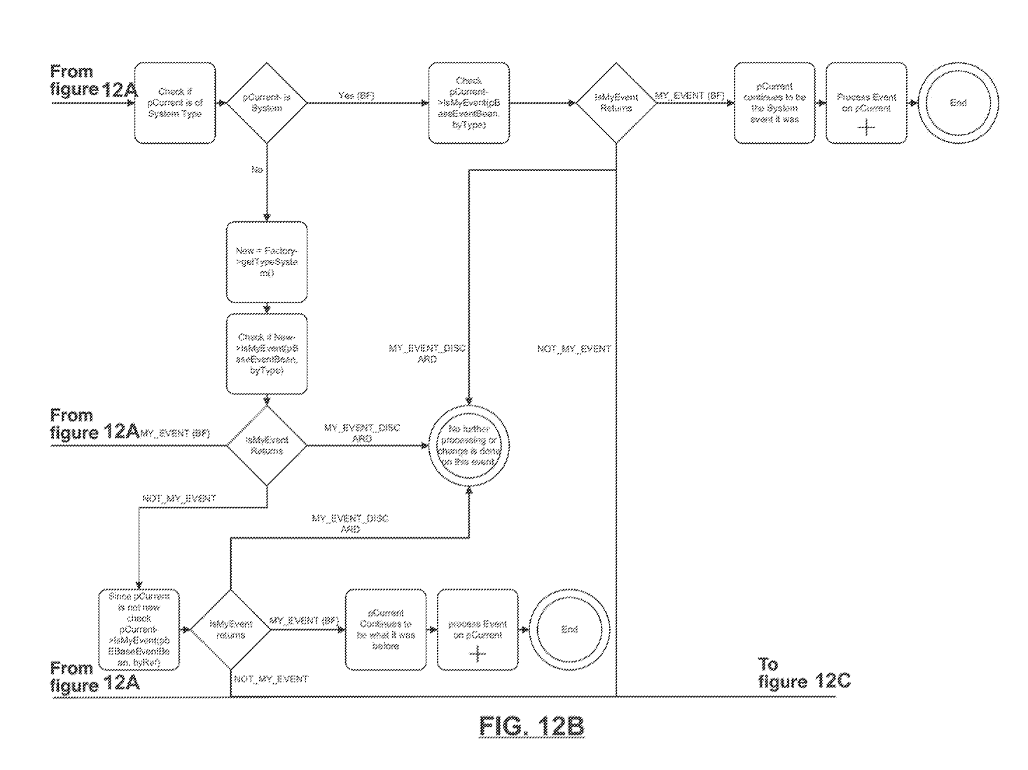

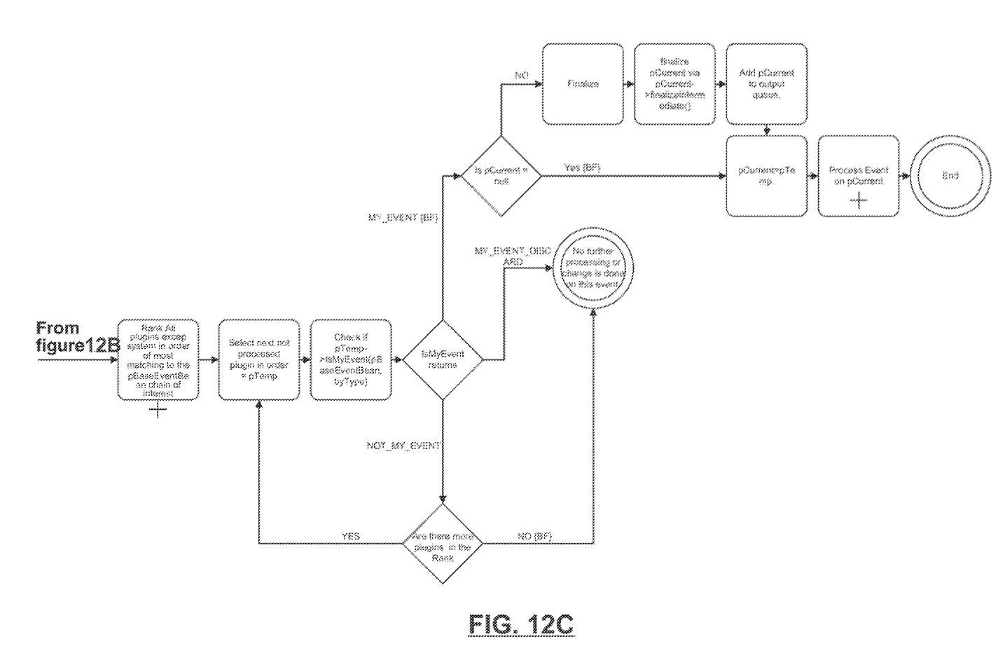

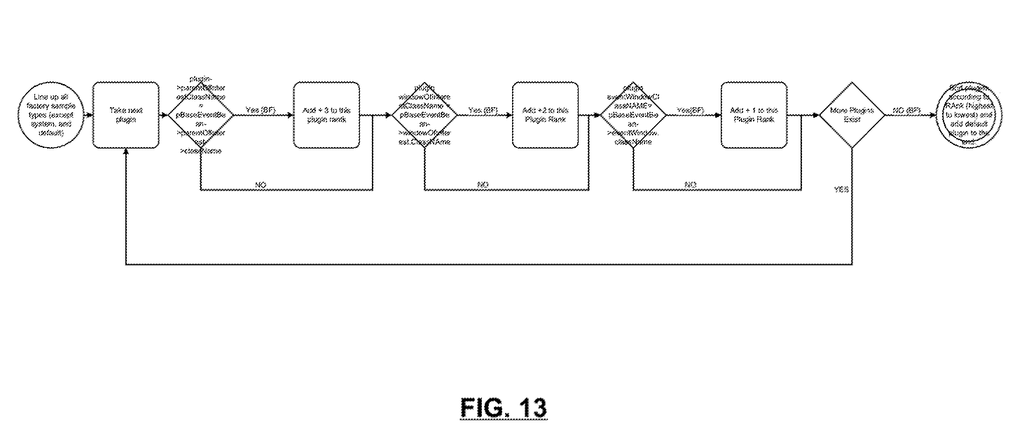

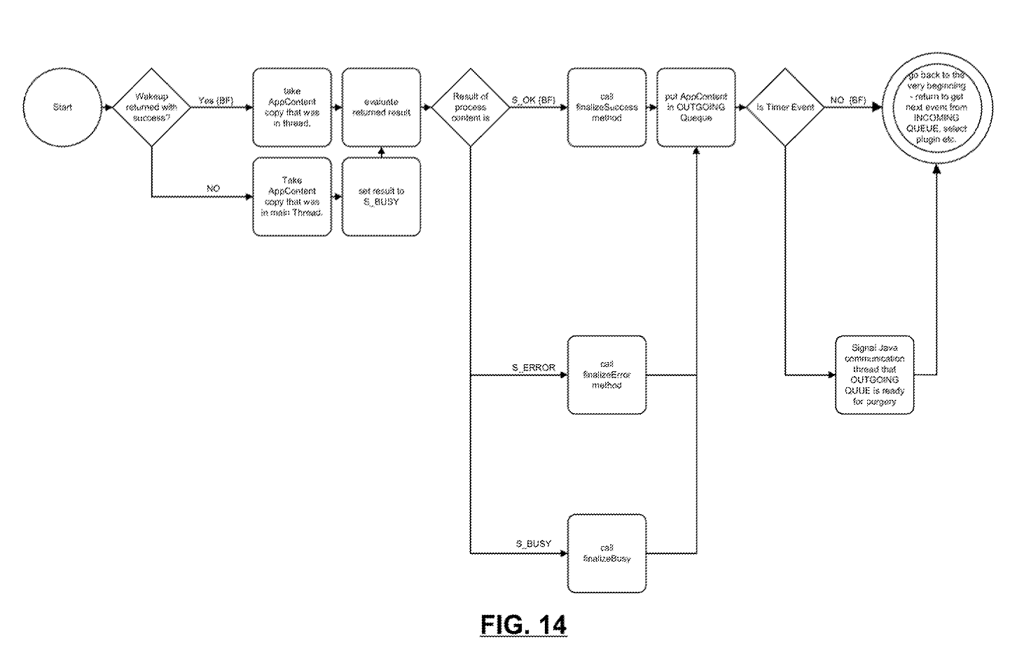

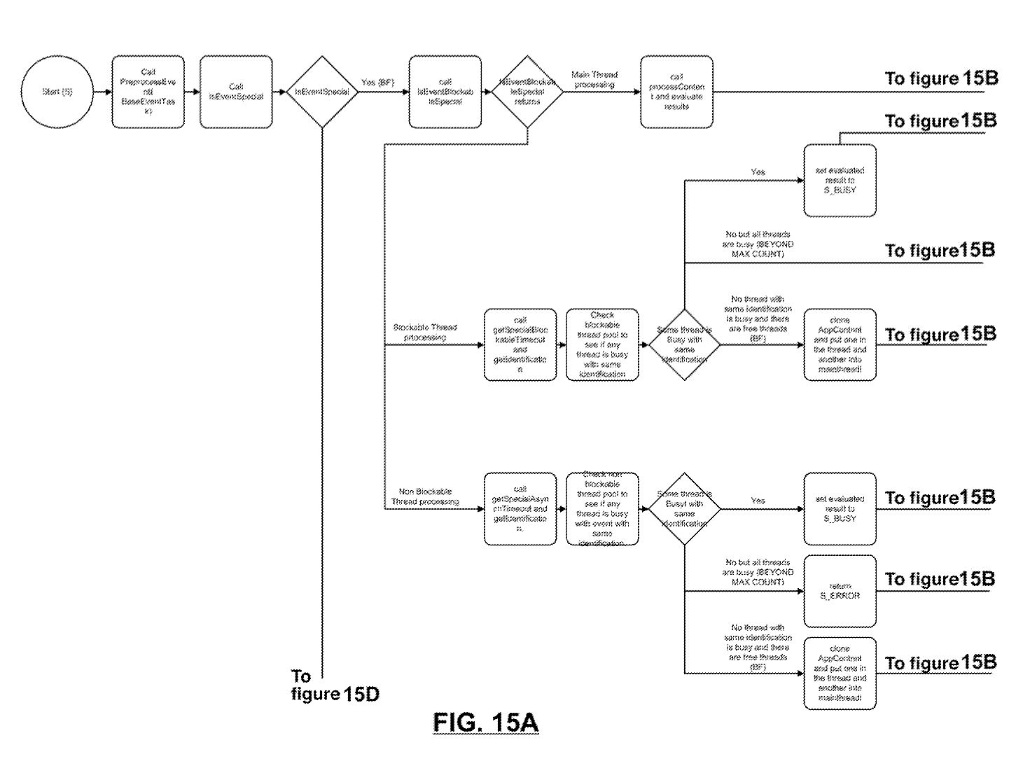

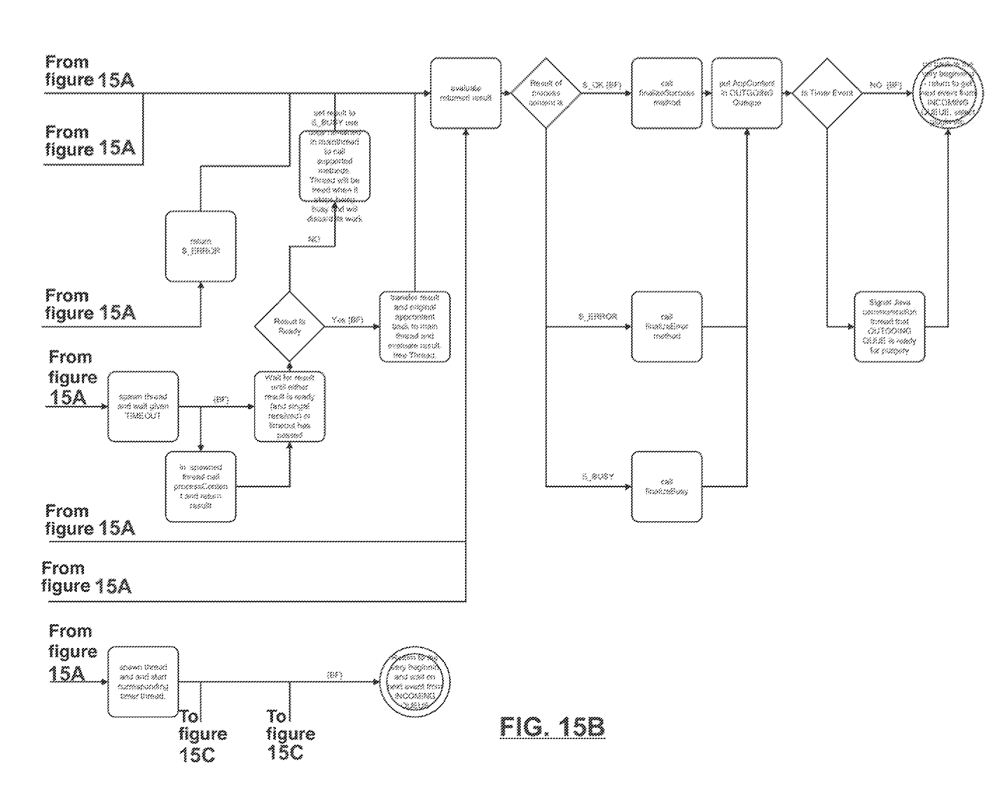

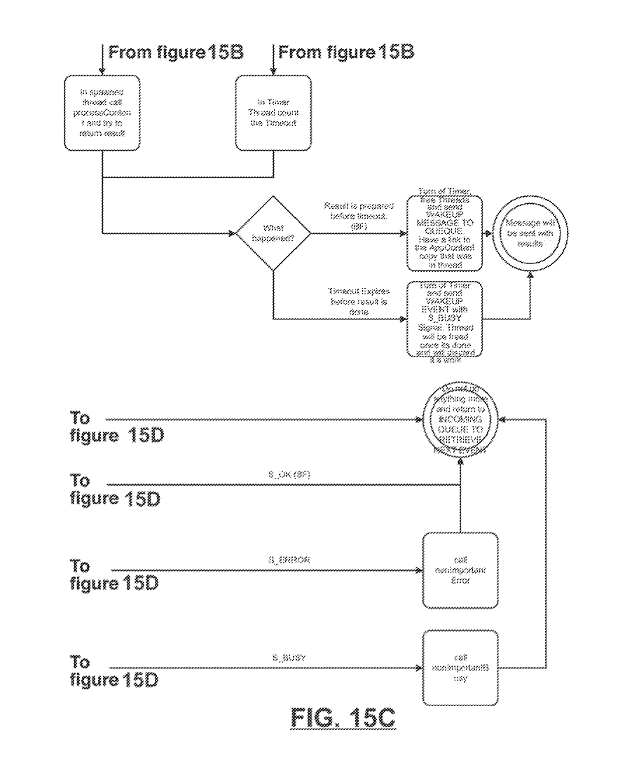

Examples of Monitoring—User event processing are shown in FIG. 12, FIG. 13, FIG. 14, FIG. 15.

Creating and Fulfillment of Discovery State Variables after Recording

State to Date: Control point recognition rules can be based on state variables, image variables, events (Low Level and MSAA), and combination of all of the above. The scope of rule evaluation is single resource at a time, which creates certain synchronization problems described earlier—which is suggested to fix via scope expansion to neighboring resources during evaluation. However if perfect synchronization is assumed the rule evaluation or application is per resource per time. Sequence rules have been postponed.

Rules usefulness evaluation: As the system develops, a minimum usefulness test can be performed to check whether current incarnation of variables and rules is enough for adequate description and recognition of control points involving events. Internet Explorer based control points were checked, where discovered states and events provide enough information for control point recognition, and the test could show whether current rule tool set is adequate for proper description of the control point.

Example usefulness procedure: To create a rule for identification of the following control point:

On a specified page of Internet Explorer web application the user clicks or otherwise activates a certain link leading to change in the page or another page. There are two ways to achieve this result
1. Click on the link
2. Focus the link (via press and drag for example), and subsequent press of Enter key.

Results of usefulness evaluation: As will be seen from example the current rules/variables tool set may not be adequate identification of all the ways the set procedure could be achieved. Specifically the second way of link activation (Focus with subsequent Enter press) may not be adequately described due to possible temporal gap between the first action—Focusing the Link and subsequent press of Enter key. Other similar temporal state based control points could be easily discovered. In addition the old problem of some state variables not being taken during event recording, could lead to similar confusion.

Assumptions

Perfect Synchronization.

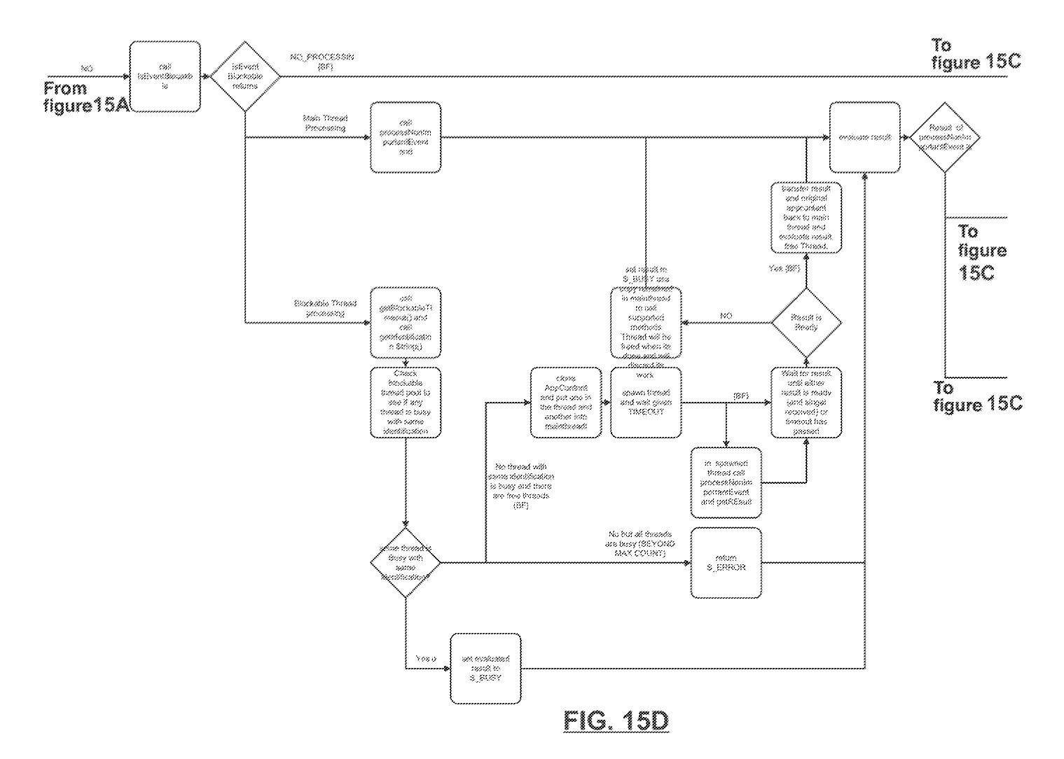

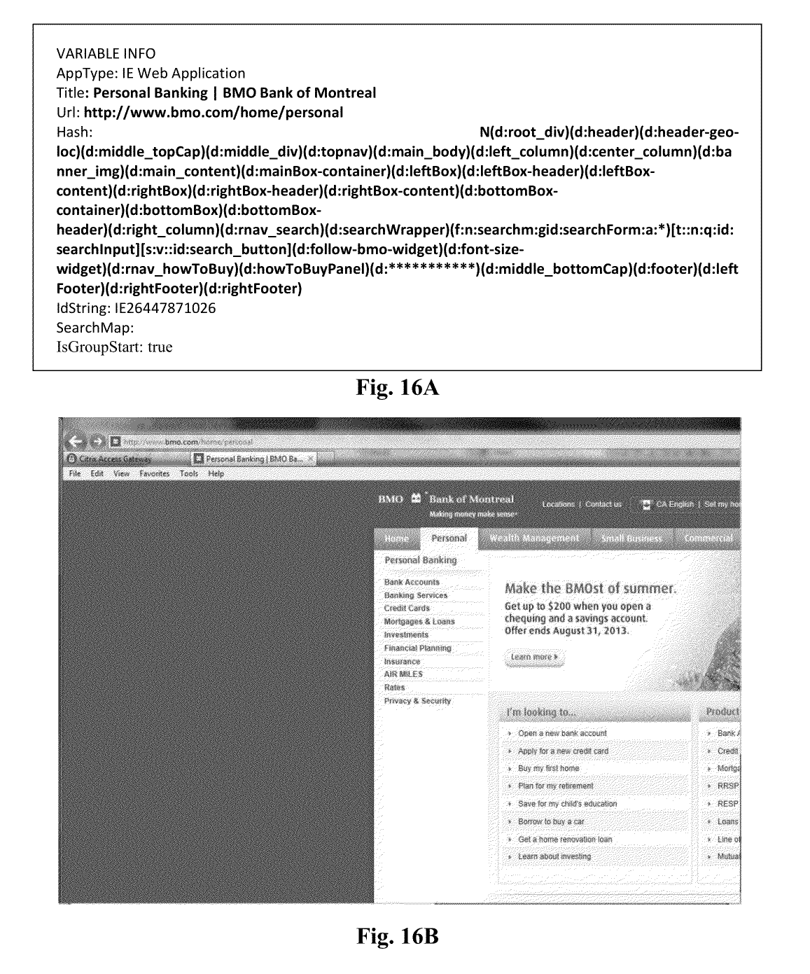

The following example relates to the use of a publicly available web page by a user to complete a task. FIGS. 16-20 illustrate screen shots and variables related to an embodiment of the system and method herein. As is seen in this example, embodiments of the system and method herein may be used for monitoring employees but also for monitoring external people such as customers or consultants. In some cases, appropriate permissions may be required before monitoring.

Details of the example—First way clicking on the link: FIG. 16A, part of the corresponding image: FIG. 16B.

Next State—Clicking on the credit card link. Some event properties are removed FIG. 17A, Part of corresponding image—coordinates are drawn on top of real image in red. FIG. 17B.

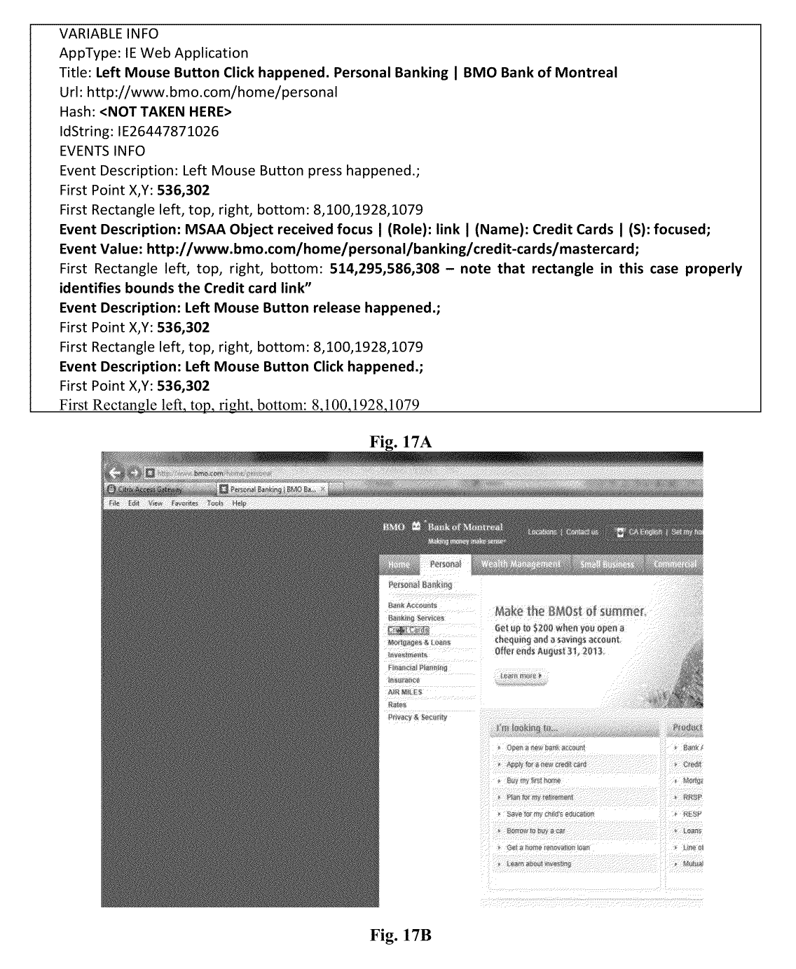

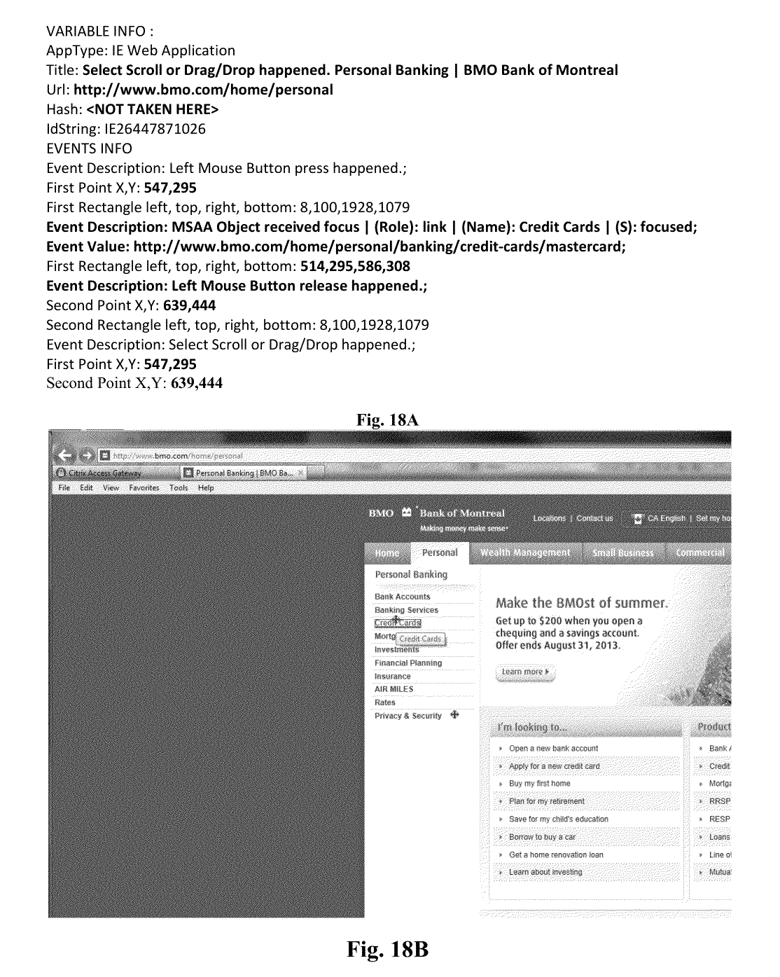

Alternative way—Focus first then gap then enter. First is Focus through select FIG. 18A, Part of corresponding image—coordinates are drawn on top of real image in red FIG. 18B

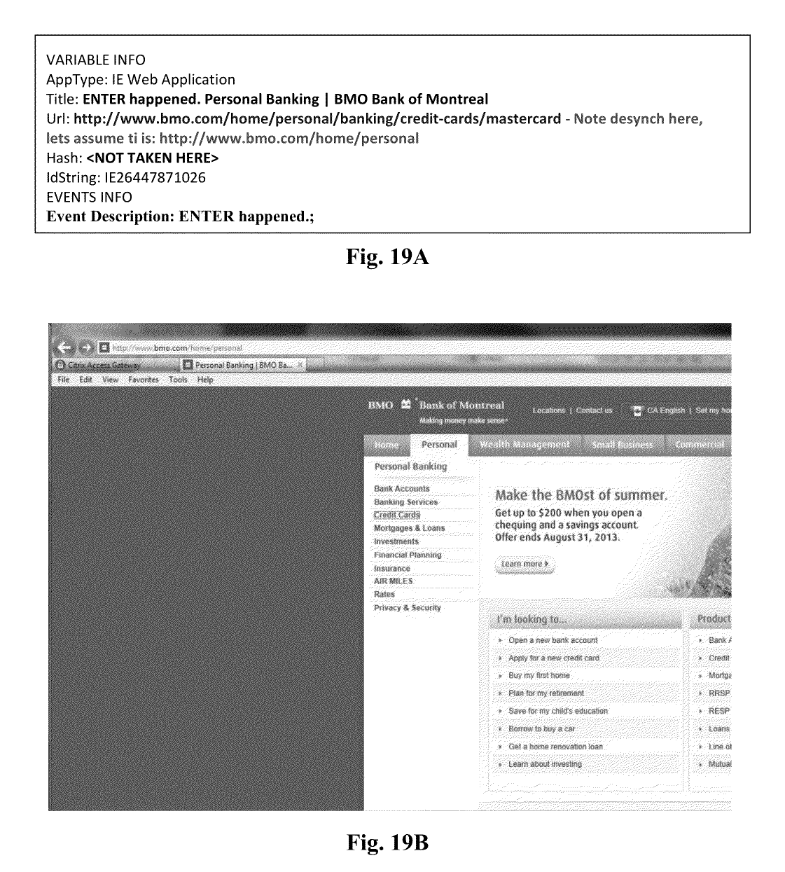

Now after gap involving possibly other applications we press enter FIG. 19A, Corresponding part of image FIG. 19B

Describing Control Point with Rule

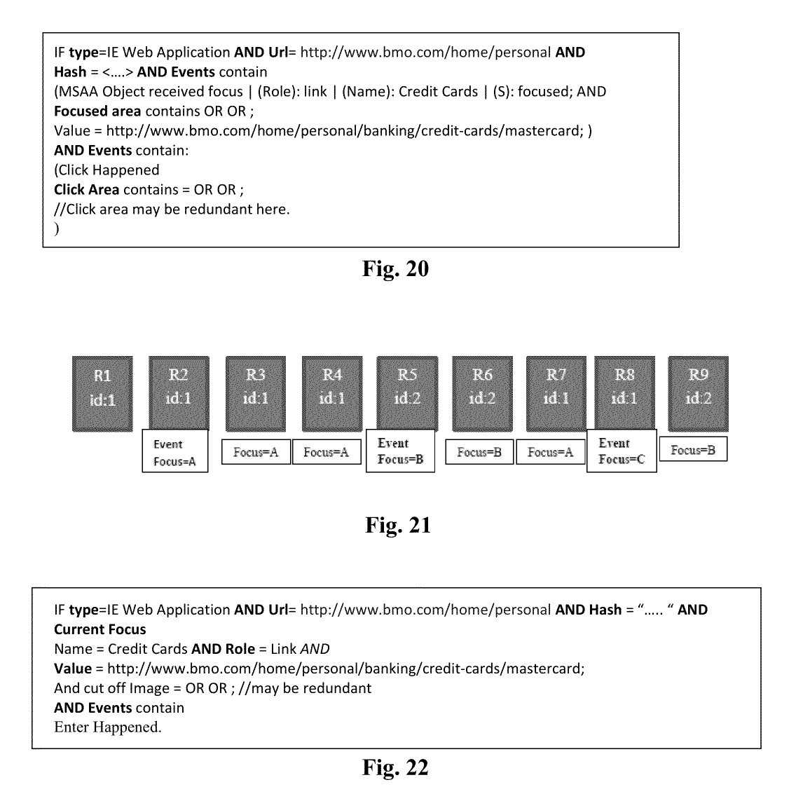

The first way—click could be described by the following rule FIG. 20.

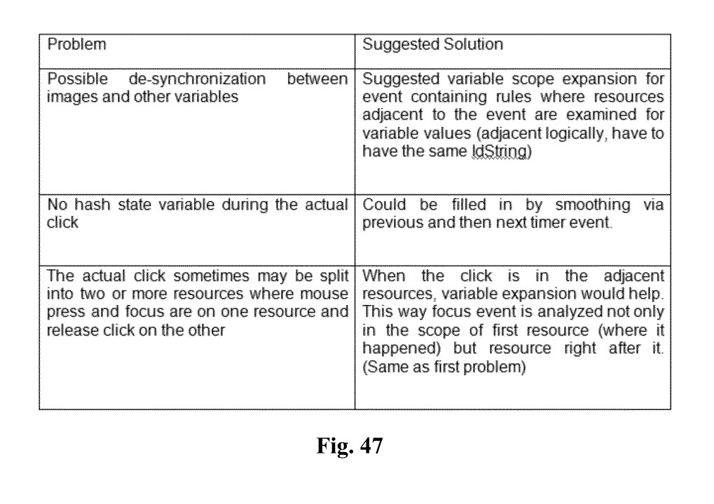

The Rule suffers from the following problems shown in FIG. 47.

The second way—Focus—gap—Enter.

There may be no way to describe this via existing rule/variable set because of possible temporal gap between Focus and Enter. There may be no way to convey last focus information for application with IdString=1E26447871026, its last focus information. There may be no focus state variable and platform by itself may struggle to provide one given that it does not see all of the recording.

Possible Solutions to Focus-Gap-Enter Way

Use sequence rules to describe the situation. Although possible in theory—this may be difficult for the user as well as for the implementation.

Have a post-recording, pre-rule definition module that would set additional state variables, as well as fill in missing state variables. The module will have full recorded sequence before it and will set the variables as it goes through the sequence resource by resource in forward direction.

Details of Second Proposed solution—In the beginning the module will in hardcoded way, create and/or fill state variables. As the system is refined (may be in later versions, after the degree of flexibility is determined) the module can have its own rules for variable creation and insertion. A similar module in may be applied to the overall architecture. Below is the description of first two state variables that it will create/fill assuming perfect synchronization. Then the assumption will be dropped and additional functionality will be described to address local synchronization problems (variable expansion).

All variable creation will be based on resources connected by the same idString. The module starts post recording but prior to rules being created and/or used. The module will analyze each recording sequence from start to finish.

Current Focus Variable

The module goes through the recording, from start to finish, maintains a map <idString, CurrentFocus> where “Current Focus” is a composite variable containing MSAA focus details. (No focus=Empty Focus variable). The details of “Current Focus” are
1. Name
2. Role
3. Value
4. States
5. Coordinates
6. Cut off from the image if Coordinates exist.

Current Focus is updated/populated for a given idString, when there is a MSAA Focus Event that happened on a resource with that given idString. Going forward through the recording, whenever the a resource with same idString is encountered, that does not itself contain MSAA Focus Event, the “Current Focus” will be injected into it. However if resource with same idString has new Focus Event, the “Current Focus” variable will be updated, and new focus information will be injected to this and subsequent resources with same idString going forward.

FIG. 21 Hash variable. This is very similar to Current Focus with but the criterion for update is simply a non-empty Hash Variable.

When going through the recording <idString, Hash> map is maintained. Whenever a resource with given idString has empty hash it is populated from the map. When there is already non-empty hash the map is updated.

Implementation note: Whether injected variables are copied and saved each time they are injected, or each identical variable is shared and pointer to it is really saved in each resource is detail of implementation. However since some such variable could have image parts, the latter may be preferable.

Interface implementation note: As seen from the example, sometimes when creating rule with image parts, instead of manually selecting an image region, the user should be able to use coordinates existing as part of event or variable.

Rule after implementing proposed solution (Second Way). FIG. 22.

To be added:
1. Variables scope expansion for Events, and post-recording module. (V rule, opposite A rule)
2. What to do when more than one focus event is being presented in one resource (split rule)
3. Other possible synchronization activities that may be done by the module.

Rules Management and Application (Execution)

Approach—The approach to rules management and application is to reuse existing infrastructure as much as possible. This means existing projects processes and rights will be utilized to manipulate rules infrastructure.

Terminology

Baseline process—some process within a project that has been selected to hold a baseline or cleaned-up version of some business process. This definition is purely logical—i.e there is nothing in the data-structures that marks this process differently than any other process.
1. Resource group—a sequential group of resources ending by a resource with isFinished=true (or simply last resource in the element). Identifies one instance of the element (state).
2. Ethalon or Source (element)—an element or state in the process (usually the baseline process) that has a rule connected to it. Connection between this state and rule may mean that the rule was originally derived from the element and its resource groups. It may also mean that the resources groups are best possible examples for the rule. The rule connection to Source element is one to one relationship. In addition Source text and Type properties are the default execution parameters for the rule (Example: If the element is activity with name: “Start of Mortgage Approval” then default execution if the Rule Action is create element will be to create an Activity with name “Start of Mortgage Approval”. In addition the lifecycle of the rule is fully connected to the lifecycle of the Source. (Deleting the source—deletes the rule, copy of the source makes the copy of the rule, move of source—moves the rule)
3. Rules creation scope—scope within which the rule is created and evaluated. There are two sub-definitions of this
   a. Narrow Scope—the Source (element) of the rule.
   b. Wide Scope—the process where the Source of the rule exists.
4. Rules execution scope—scope within which the rule can be executed—This is the project to which the Wide Creation Scope of the Rule belongs.
5. Ruleset—a group of rules ready for execution together. For this release it is suggested that default Rulesets are based on Wide Creation Scope Process. This means default Ruleset holds all rules belonging to certain Wide Creation Scope Process. The user can adjust individual Rules minimal fulfilment degrees, and change global Action.
6. Creation Scope for Sequence Rules—scope within which the rule is created. Since a Sequence Rule is a combination of Simple Control Point Rules, its scope is a sub-process element, which connects to a process that holds the a sequence of ethalons connected to simple Rules that are members of the sequence rule. <DOING THIS MAY REQUIRE TO ADD SUBPROCESS CAPABILITIES NOT ONLY TO ACTIVITIES BUT ALSO TO STARTS AND ENDS>. Otherwise source for sequence rule holds the same Resource groups, that represent the whole rule. —This part requires more thinking. NOTE: The sequence of ethalons in the subprocess, may not actually reflect the complex rule, just the simple rules themselves.

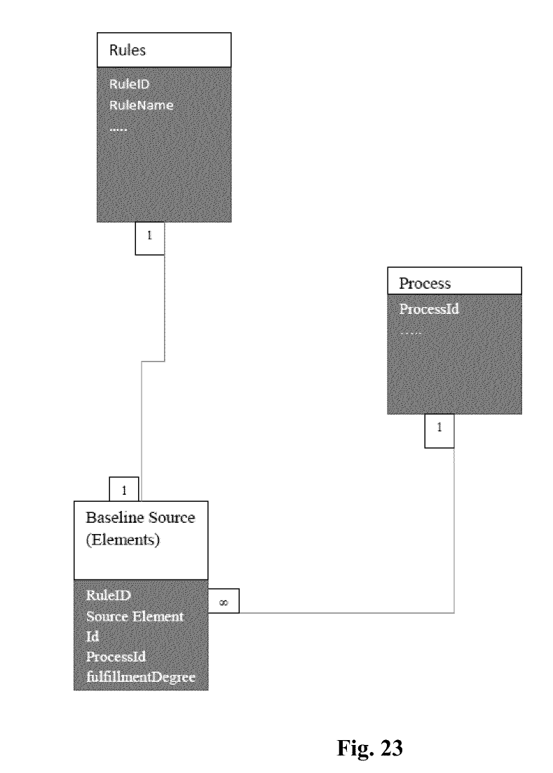

Data relations—Data relationships below may not cover all subtultitles of the sequence rules. Data relationship is not an ER diagram describing a database. All components could sit in different places (Database, XML, etc)—FIG. 23.

Execution Parameters—Execution parameters—parameters that are specified prior to RuleSet execution, and govern the degree of fulfillment (required preciseness of rules) as well as actions expected from, rules that reach a set degree of fulfillment.

Uses Cases & Lifecycles

Go through baseline, identify and create new control points (sources). For each:
a. Create new rule link to source.
b. Modify Rule while viewing source
c. Modify source resource groups
d. Modify Rule, and rerun against sources if required. (saving the rule saves the process and vice versa)

Execute the Rules
e. Select the creation Wide Scope process and open corresponding ruleset
f. Adjust parameters and preselect rules
g. execute

Review Executed Material in Compare Mode (Baseline Process at Bottom)
h. For well-done findings—update sources via make the same if required (Via log link to rule)
i. For false positive or false negative, Validate rule against both sources (bottom) and current situation (top). Make changes to conditions as desired. Verify changes on both top and bottom. If required add new situation to the sources as another resource group (via make the same)
j. For extra precision—narrowing down the rule
   i. For source situation—split as desired and create new rule for split action. Verify (validate) rule against current and sources.
   ii. For current situation—simply create new source at the bottom from current situation and make precise rule for it.
k. For new situations that do not involve changing current rules, create new source from situation and create new rule for it.
   2. Repeat the above in any order.

Management Functions

Copy/Move—between processes and projects—facilitated by source element copy or move as well as process copy. Copy may be a deep copy.

Disable—disabling the process, disables all rules that have source in that process.

Delete—delete source and rule must be deleted as well. If the process is read-only no change occurs

Additional delete function might be required which deletes the rule but leaves the sources

For version control purposes the rule may actually never be deleted, just the connection will be deleted

View source—source elements must be visually different from other elements.

Version control—there is opportunity to make a copy each time a process is saved. It may be desirable to do similar version control for rules. Alternatively the rules themselves do not version control.

Right Administration

Because management of rules is fully facilitated through their sources there is no change required to current Rights administration.

Rules Application (Execution)

Whenever the rules are being executed, several preconditions are checked before going to into every process in selected scope
1. Execution log is shown to be later given to the user
2. Each process in scope is checked, to contain only sequences (last element one row and first element on the next is considered a continuation of the sequence). If the process contains anything else (decisions, loops, etc.), such process will not be assessed and corresponding message should be recorded in the log.
3. If any modifications or process additions are to be expected, all rights may be checked for every process. If rights are insufficient the process will not be assessed/copied and corresponding messages should be recorded in the log.
4. The rules within a selected ruleset are applied independently one by one to each sequence according to set execution parameters, yielding result (0 . . . 1 fulfilment degree for each rule). No changes are made (no actions are executed), until all rules have been run on the whole sequence, in order to find the winning rules if there is a conflict. Complex sequence patterns can be run after the simple point (r1(r1)*) are run but this is a detail. Once run on the whole sequence, actions can be done. If there is a winning rule and candidate rules that are clashing on resource/resources the application should do the following:
5. Perform the winner action. (tag the resources involved with winner rule reference)
6. For all resources and elements participating in the change that also have other rules achieved degree of fulfillment threshold, but to less significant extent than the winner, they should be tagged as candidates for their rules and their actions. (additional storage schema may be required for this information)

Possible Solutions

Consider a clash when one or more resources participated in changes that are mandated by different rules that reached the fulfillment degree threshold

When both point and sequence are participating and clashing, prefer sequence.

Sequence vs sequence do min max operation between sequence peaks. Example: r1(r1)*r2(r2)* vs r1(r1)*r3(r3)*. r1 peak −0.79, r2 peak −0.75, r3 peak (in the same place as r2) −0.7. First rule wins other is candidate
1. Inter-process sequences—Due to process split functionality one sequence can span multiple processes. (end of the sequence in one process is a sub-process element that points to next process, where first element is the continuation of the sequence). In such cases the rules may be applied to the whole sequence in the following way:
2. If modifications are expected and changes are “in process”, the system should check whether all process can be modified by the user, and lock the processes, until all the changes are done. If changes are expected and result=“copy” or “copy in another project” the processes should be copied all together (and their sub-process links updated) (if rights allowed), and then locked for the action. In case there are rights or lock problem, Rules execution should stop and add appropriate message to the log. (Whether the lock happens gradually or all processes are locked together is left as implementation detail)
3. Whenever action (specifically create element) of the winning rule spans elements on process boundary (i.e. some resources, from previous process and some resources from next), the action should create the element in the previous process and put all required resources in it. If the action creates an activity—then a sub-process element with link should be created instead. If the action creates a start element—it should create another empty sub-process element next, link it to next process and link the start and sub-process together. If the action creates an end element—create an empty sub-process element next to it link it to next process. In the last two cases the name of the sub-process element should be the same as the name of next process.

Licensing Extension—New

Ideal situation would have a group of users who could utilize this right. Let's call this group—super-analyst. Basically a super-analyst is the same as analyst, but he can in principle utilize any of the rules functionality (create, execute, manage).

All other types of users cannot execute any of the rules based functionality. They have all buttons and other controls that lead to the rules functionality but all these buttons are disabled. The only exception may be implicit intelligent find (the successor of highlight similar, that works on default rules template for any given AppType, will be described separately, and has no explicit rules interface).

Super-Analyst group will impact the following items
Admin Interface (new group and all that is required for it)
Work as super-analyst button and related functionality
Licensing—right now includes only two groups and number of concurrent users for each. Will have to include three groups and number of concurrent users for each. For backwards compatibility current licenses should be decoded as having 0 super-analyst
Login, Logout active sessions functionality
Audit log changes for groups.

Regular Analyst can see that certain element is a source and if he has rights to the process, can delete or move/copy rules implicitly, but cannot execute or edit rules.

Interface Components—Start

There are two major components to the interface and related functions.

Rules Management/Editing

Rules Execution

Rules Management/Editing

Regular Edit—as per Notes on Screen 3 document

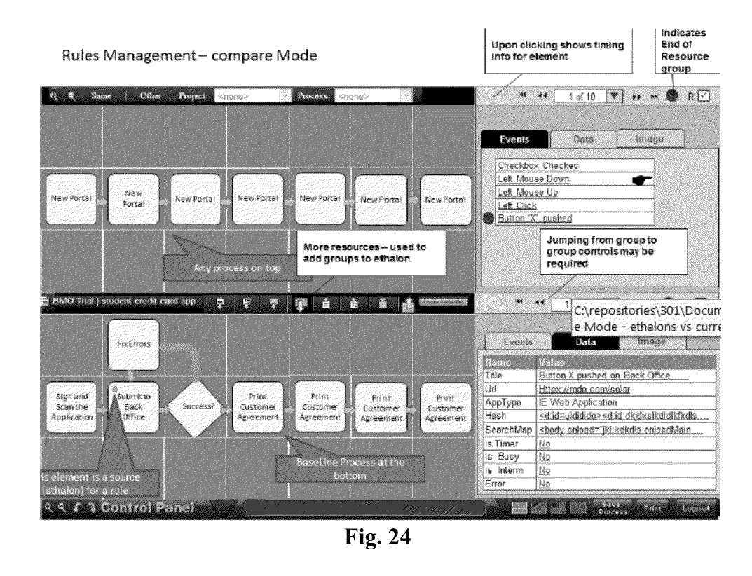

Comparison Mode FIG. 24

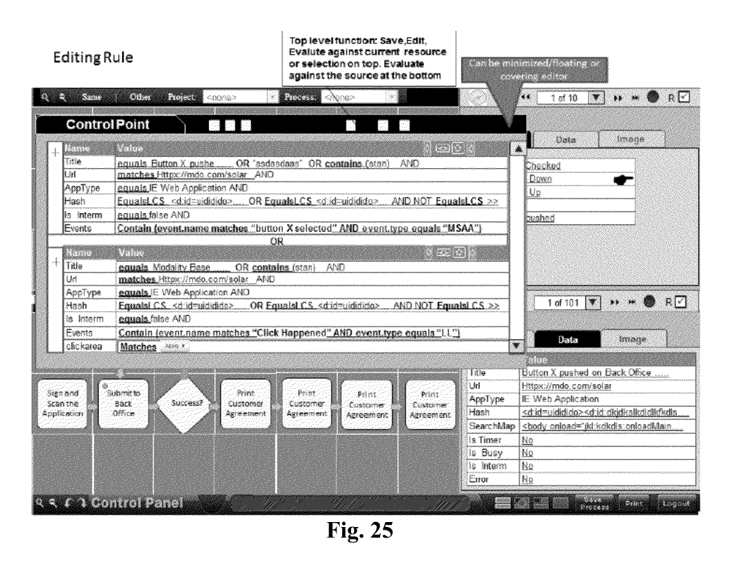

Comparison Mode rule editing—called from the ethalon source element FIG. 25

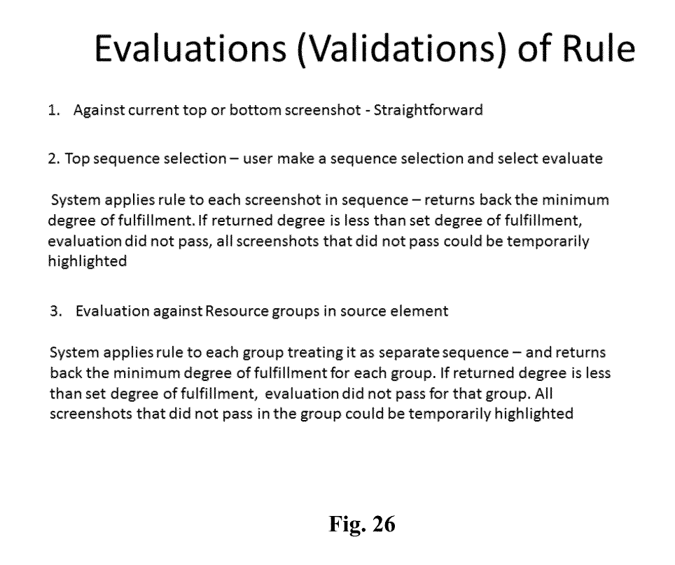

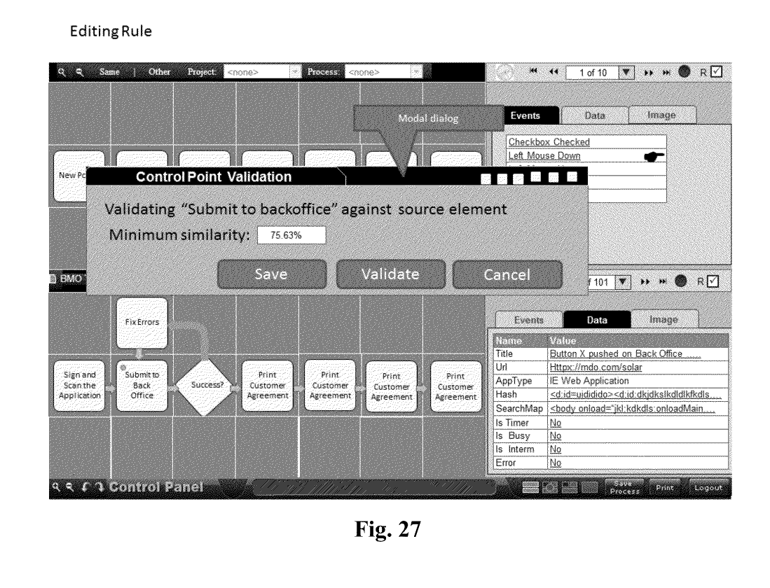

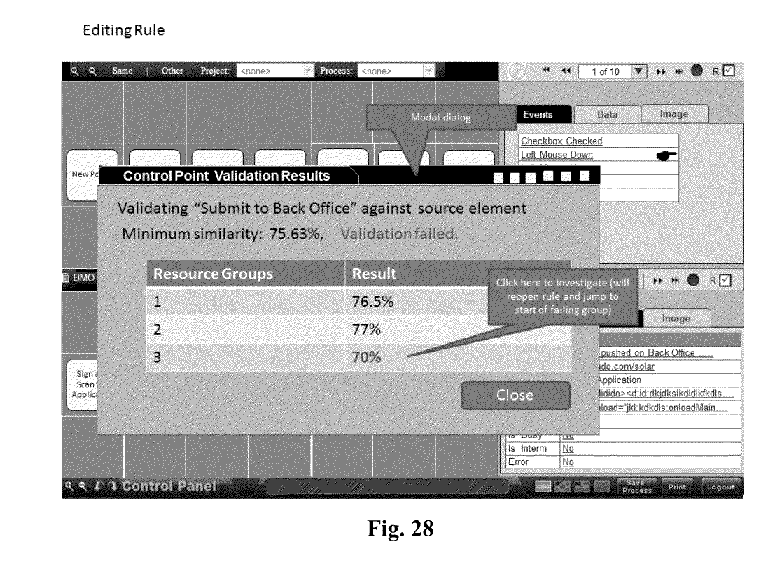

Comparison Mode rule validation against sources/current (results presentation might be further influenced by Rules execution results presentation)—only against sources interface examples are shown. FIG. 26, Editing Rule FIG. 27, Results FIG. 28.

Comparison Mode source reforming

Rules Execution (Application)

Feature two major components

Pre-execution Wizard—called by pressing execute button in the control panel.

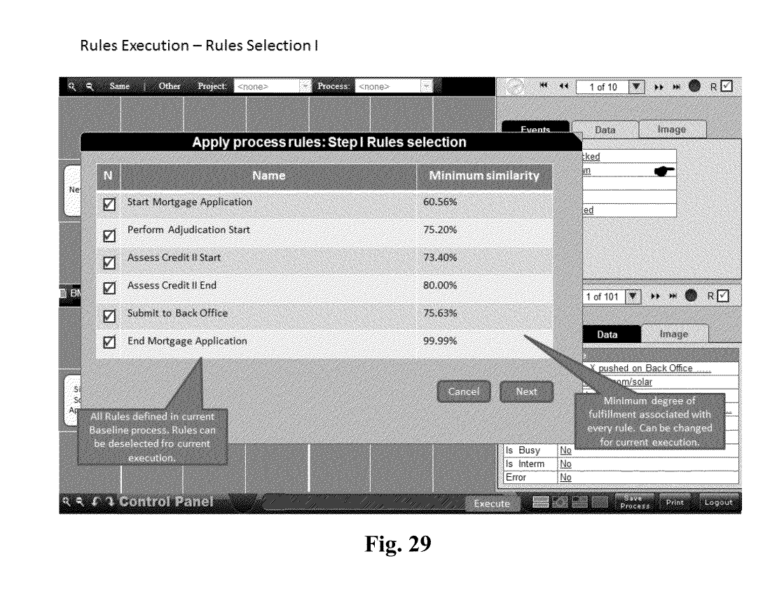

Rules selection and execution parameters change—(What rules to Execute) FIG. 29

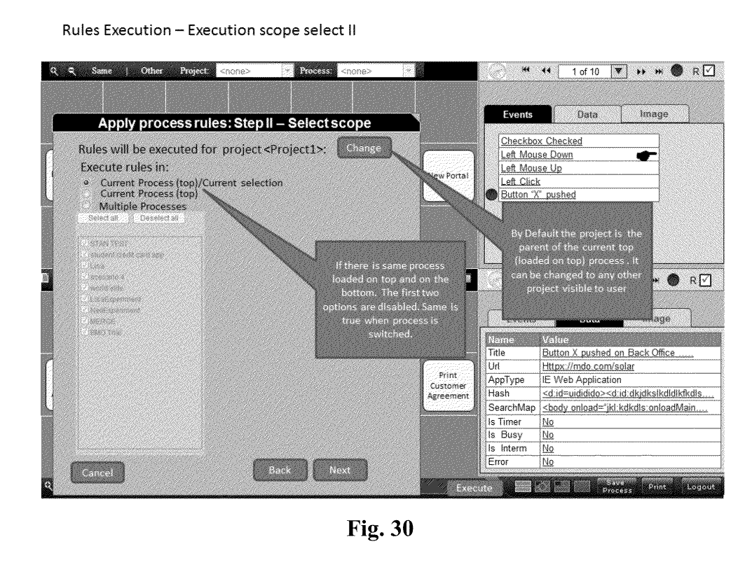

Execution scope selection—(Where to execute Rules) FIG. 30

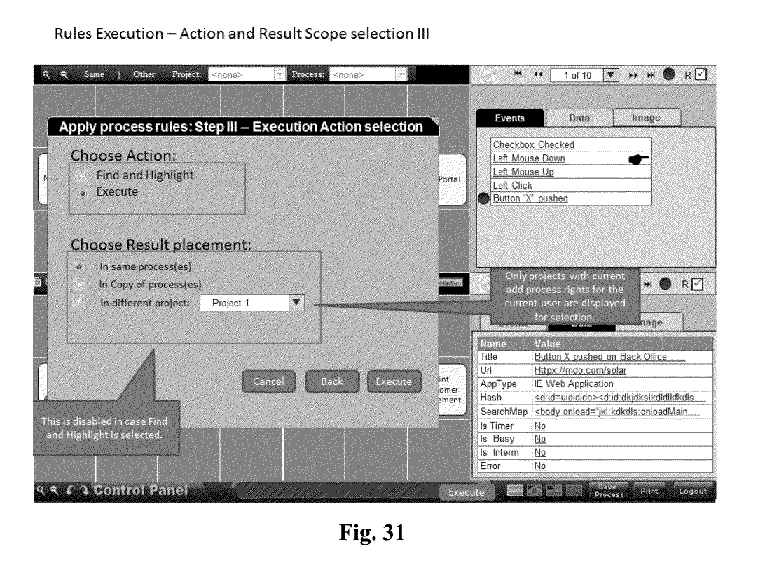

Execution Action and Result Scope selection (What action, and where to put results if applicable) FIG. 31

Post-execution—Results and log viewing

Execution log—showing which processes were processes successfully and which were not for whatever reason.

Results—a show dialog that allows enumerating changes/findings and diving or searching each finding. Results themselves can be divided into the following stages:

Selecting which results to view and how

Viewing Results according to selection

Diving into specific result if required, by clicking on the result loading correct process to the top editor and highlighting the found instance.

It may be noted: Execution log and Results remain in memory for the user until either the session expires OR new execution is ordered. Once hidden and recalled again—should resume on the same screen where it was hidden. One can reopen latest result by clicking the show log button in Control panel.

It may be noted: When there is a conflict (i.e more than one rule fulfilled on a given screenshot, and one rule is the winner), diving into results allows not only to show found control point, but also indicate other candidate rules (as discussed in rules execution above) but click on them and view the source element of given rule on the bottom.

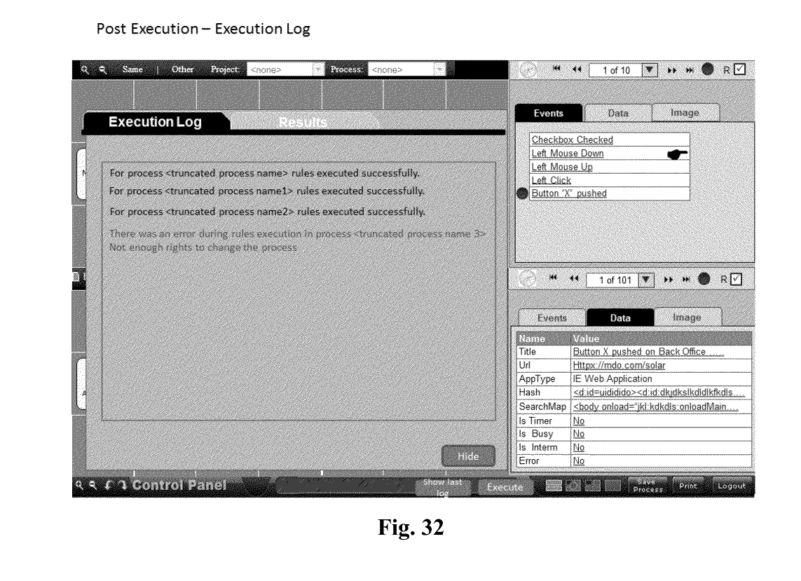

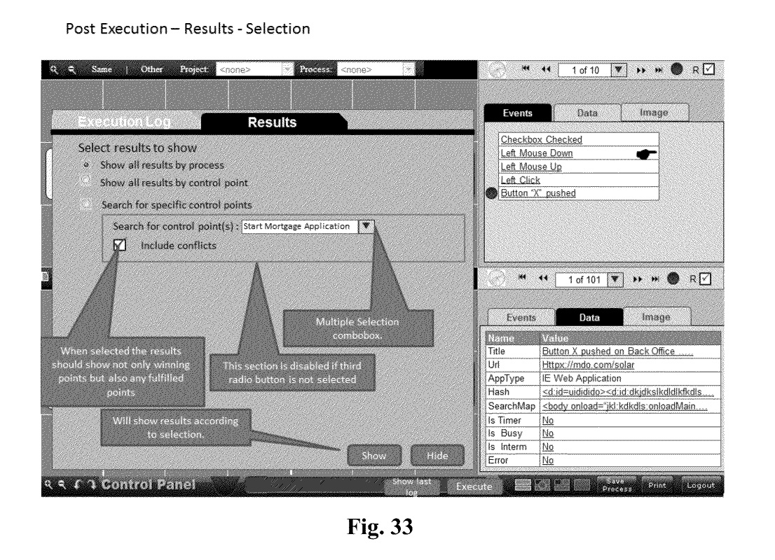

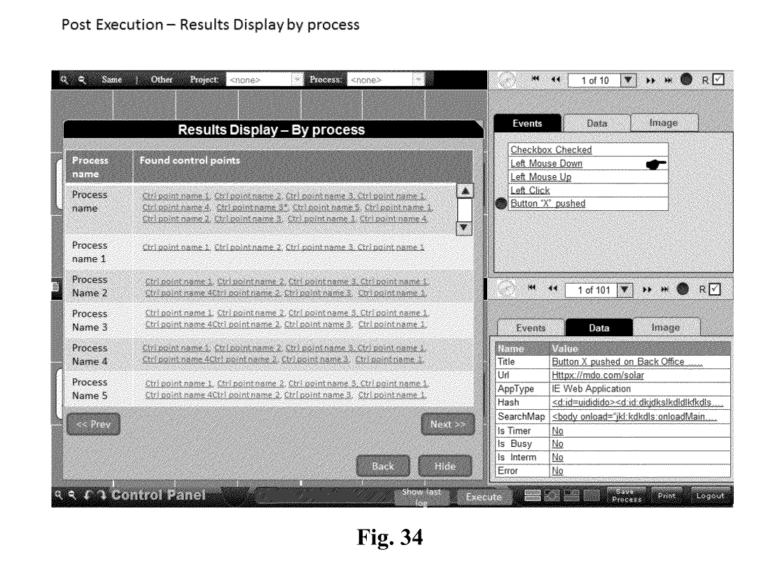

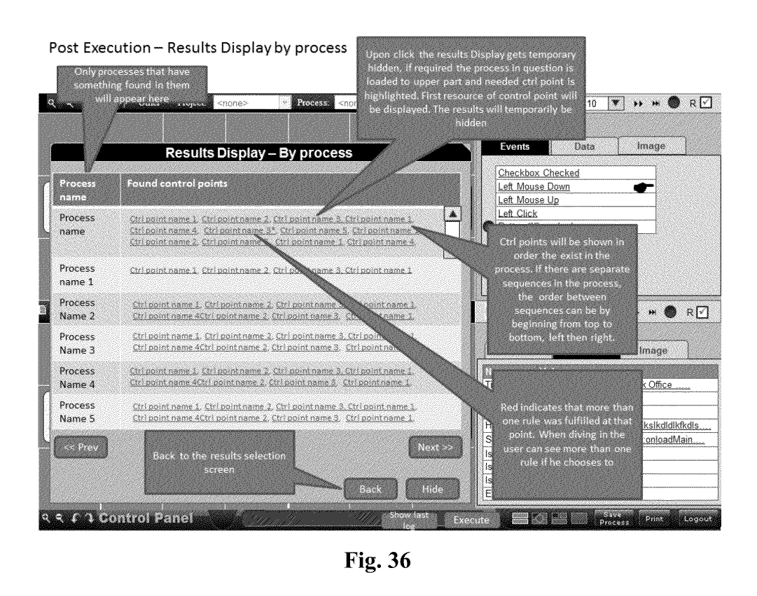

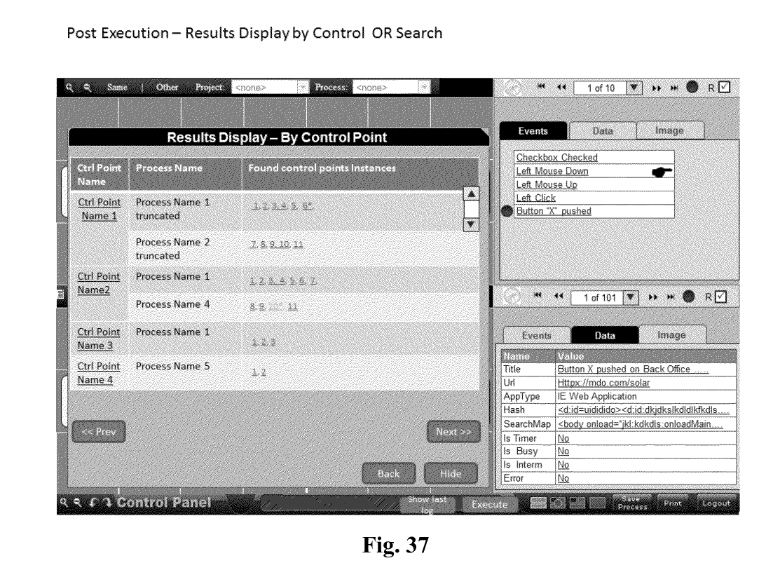

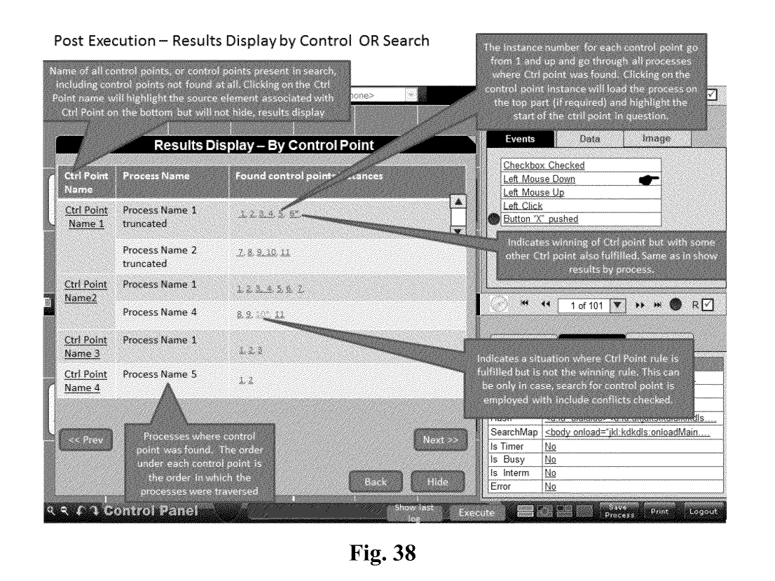

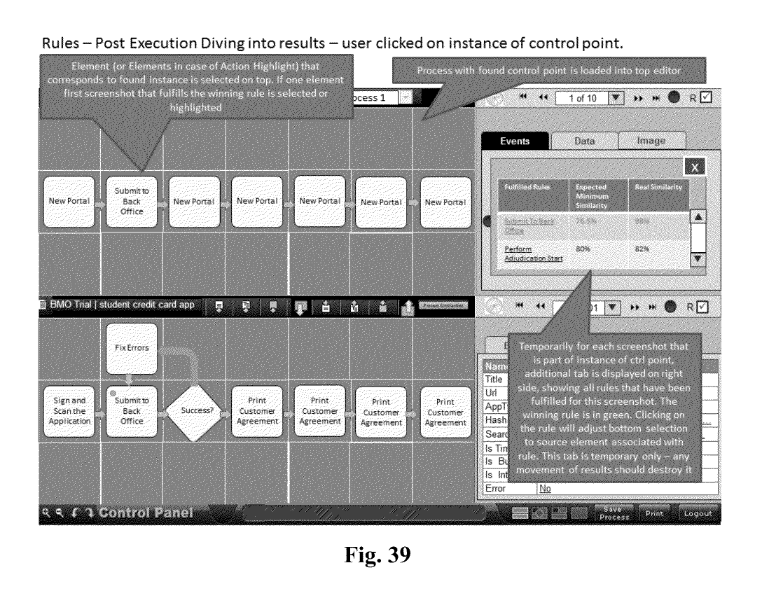

FIGS. 32 to 39 illustrate Post Execution screenshots.

Rule Validation amendment—Requirements amendment

Original requirements for Validation presented results by resource groups. This means that even if one resource in the resource group was not fulfilling the rule above the minimum degree all resource group was described a failure. This however did not allow for quickly narrowing down on the resources that failed validation.

The modified implementation creates success/failure groups in addition to resource groups. As such all resources that sequentially succeed or fail, within one resource group constitute one success or failure group. The success/failure report displays these groups with minimal degree of success on each group.

Example: Element contains three resource groups: R1 R2 R3 | R4 R5 R6 | R7 R8 R9

R1—(s)uccess, R2—s. R3—f, R4—s R5—f, R5—s, R7—s, R8—s, R9—s.

Result Groups (total of six):

R1,R2—success—degree min(R1, R2)

R3—failure—degree R3

R4—success—degree (R4)

R5—f—degree (R5)

R6—success—degree R6

R7,R8,R9—success degree min(R7, R8, R9)

Preface—Goals

New Deeper Discovery is intended to improve the fidelity classification of recordings into process states. Specifically it is intended to help with the following functions:
Automated change of Recorded Names and other Discovery variables based on previous information and set rules.
Automated detection of start of process and end of processes.
Help with Reclassification of the recorded states based on already analyzed information

These goals may be accomplished by combining rules pertaining to Discovery information (variables) obtained through OS and recorded images analysis and detection. The information would be analyzed in two phases. In addition to system information—now user event information will be obtained.
Real time changes during recording (usually based on OS information)
Post Analysis changes and changes suggested

This direction is fully inline with remote monitoring of many users.

Major Logical Definitions
1. Recording Variables—information obtained through OS that pertains to recorded information for current screenshot. Simple variables are of String or Integers types. Complex variables include combinations of String and Integer parameters as well as lists. Examples of these variables: a) Element Title; b) Title; c) Url; d) Hash; e)AppType; f) WindowClass; g) Event (user event); h) Events List(s); i) triggering Event—event that triggered this round of screenshot recording.
   NOTE: Screenshots can be taken when triggering Events arize or when time interval has passed. (normally 1 sec). In first case the triggeringEvent variable of the screenshot must be populated with the even that triggered it.
   j) Element Type; k)split to next or not (this is a special variable—really a setting); l) username (readonly)
2. User Event—special case of Recording Variable that pertains to event done by user. This is a complex variable with the following members.
   a. EventString—Required
   b. Event coordinates X (Optional)
   c. Event coordinates Y (Optional)
   d. Event Type (Low Level/MSAA/App Specific)
   e. Triggering or Not—If event triggers the screenshot then the type is set to 1 otherwise it is 0
   f. event timing (readonly)
   g. More attributes if required.
   Pertaining to current screenshot there are 3 general event based variables to be considered.
   List of Events that happened between previous and current screenshot
   List of Events that happened after this screenshot but prior to next.
   Triggering Event (there might be no such event)—Event that triggered this screenshot if and only if the event is triggering.
      Examples of Events
         a) Low Level Event:
            1. EventString=“User pressed CTRL+SHIFT+V”
            2. Event cooridnates=N/A
            3. Event Type=LL
            4. Triggering=NO
            5. Event Timing=“103940348208202”
         b) MSAA EVENT
            1. EventString=“User clicked on Exit Button”
            2. Event coordinates=Button X,Y coord (if available)
            3. Event Type=MSAA
            4. Triggering=NO
            5. Event Timing=“94039405345830002”
         c) App Specific Event
            1. EventString=“User changed cell A6 in NewProb sheet Of Workbook1 (new val)”
            2. Event Coordinates X=A Y=6
            3. Event Type=Excel
            4. Triggering=NO
            5. Event Timing=“39408340234802384032”
3. Timing information for each screenshot—same as now.
4. Rules—entities set by the analyst after the first recording. They allow taking corrective actions based on set of conditions met by the recorded information. The actions include (although other actions are possible)
   a. Change value of recorded variables (like title name)—including assignment of other variables and regular expression.
   b. Ignore currently recorded screenshot and its information
   c. Change kind of Element
   d. Make decision on split or merge
   e. Make start process/end of process decision
   f. Create new variables
   Rules conditions are based on:
   Existence checking (whether certain Recording variables exist or not)
   Regular expressions (content of certain variable or member matching expression)
   Boolean algebra (AND OR NOT)
   Results of image analysis (object detection and recognition/template matching) that amount to yes-found no—not found.
   There are two types of rules
      Real Time Recording rules—conditions are evaluated and actions are taken at the time of recording. The rules must perform fast and therefore there are limits to number of conditions for these rule and image analysis conditions are not allowed in real time.
      Post Analysis rules—conditions are evaluated and actions are taken during analysis upon analyst selecting to execute the rules on subset of recording or full recording. Since no real time action is required complex image analysis including training and learning is possible.
   Examples of Real Time Recording Rules (Some explanation will be provided in respective sections)
   If Title matches (“<regexp>”) then replace Title,dTitle with regexp(Title=“dkdk”);
   If Title matches (“System tray”) then Hide.
   If Title matches(“MYBUSINESSAPP”) AND exits TRIGGERING EVENT matching(“*Click on”) and Image(img) matches CLICK AREA, then split at this screenshot and replace Title dTitle with “Start of End Card Call” and make this element type start. (Post Analysis only) NOTE: All rules are set through GUI user interface—examples here are for explanation only.
5. Split hint—an image analysis technology, that allows presenting the user with possible state reclassification based on previous manual reclassification of same activities. This technology is used during post analysis and is intended for situations where rules based analysis has failed or is unavailable. The user selects source area and asks the system to reclassify target area into states based information from the source area. Then each screenshot that behaves as start of iteration of certain element will be used as etalon of start of that element and is tiled to certain size to reduce noise. All target screenshots are reduced by tiling as well (Scale/Size important) and compared using average error distance or other formula to the etalons. Based on best scores the technology suggest how to re-split the target.
6. Recording settings—values that influence recording behavior but are not directly connected to change of business logic. Example—Listen or not listen to low level events. There are several recording settings in the application now but there will be many more.

Major Components
1. Recording
   Event Recording Module
   State Recording Module (we have it now—it will be expanded)
   Real Time Recording Rules Evaluation Module.
2. Post Analysis Internal Modules
   a. Post Analysis Training Module
   b. Post Analysis Rule Evaluation Module
   c. Split Hint evaluation module
3. Interface
   a. Real time recording Rules Interface
   b. Settings Interface Expanded
   c. Post analysis (Image based Rules) Rules setting Interface.
   d. Split Hint Interface (Most likely comparison mode based).
   e. Image Visual Diff Interface (Currently Being Built)

Recording

Recording consist of following functional modules implemented in C++/Java
1. Event Listener—Listens and records three levels of events: (Low Level, MSAA, Application Specific events) and populates related queues. In addition performs trigger analysis on certain events to determine if event is triggering—posts special request to State Recording Module. Event Listener and Trigger Analysis are governed by Recording Settings and Real Time Recording Rules. (There should be special interface for setting up rules for making event triggering). Event viewer is responsible for gathering user side of the user-system interaction. In addition Event Listener component is responsible for robust hooking/unhooking of events for related active applications on all levels.
2. State Recording—Is called once every certain time period AND after triggering event (with some modifications). State Recording is responsible for system side of user system interaction and its goal is to get internal structure of the window in question (active window or window under event) and populate related recording variables. This module has specific plugins for certain types of applications. Currently there is a specific plugin for Internet Explorer. There are special plugins being built for Excel, Access, Console Applications, Attachmate, and .NET/MSAA apps.
3. Screenshot taking component—is used by both Event Listener and state recognition module to take screenshot of the window (or part of window in question)
4. Real Time Recording Rules evaluation module—module that puts populated recording variables through rules setup previously, and modifies the output in real time according to them.
5. Information Sending Component—responsible for sending or storing recorded information on the server and or browser. Currently it is implemented by sending screenshots directly to server and putting process information into JavaSCript (browser). This will change for Remote Monitoring.

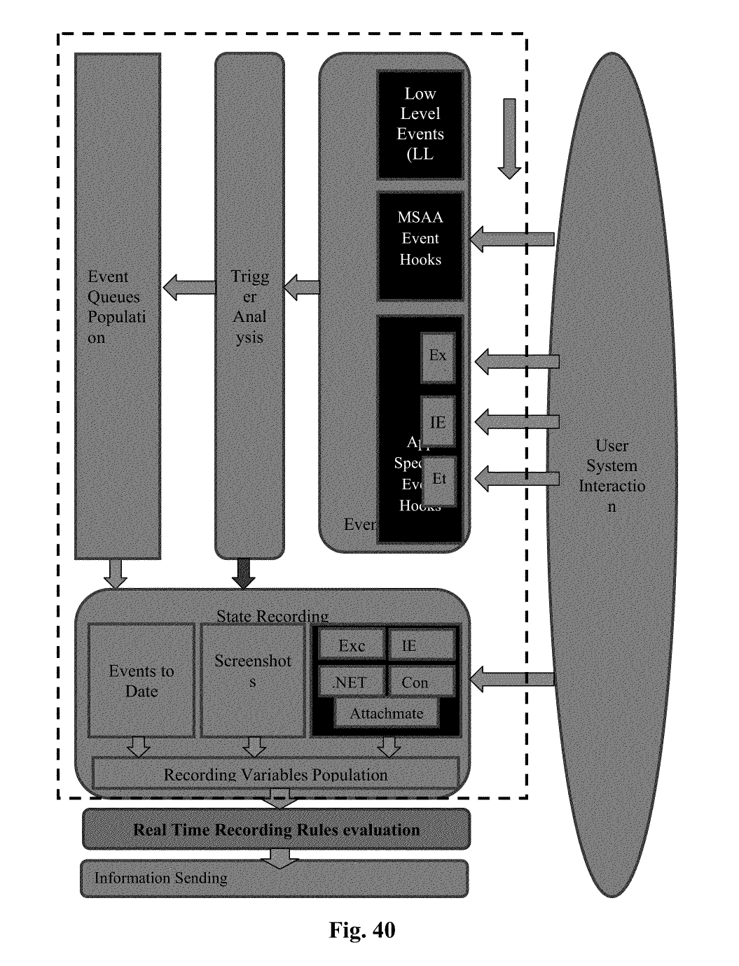

FIG. 40 illustrates a diagram for recording.

Recording—Details
1. Normal Flow of Events
   a. The recording is started by the user.
   b. System passes the following information to the recording agent and processor
      i. Real Time Recording Rules
      ii. Special Type of Real Time Recording Rules Identifying certain events as triggering
      iii. Recording Settings
   c. System starts recording according to recording settings. Some settings and special rules can be preset by default.
   d. System records events as they happen. If these are not triggering events, event queues are populated
   e. Once per second (or other time) State Recording happens, gathering state info as well as all the events that happened to date (event queue is purged). No event is set as triggering. The resultant information consists of
      i. Events up to now (from last time State Recording Happened) including Timing information
      ii. Screen state information
      iii. Resulting populated Recorded Variables
      iv. Coordinates of the area to take screenshot
      v. State Timing information
   f. Once information is gathered it goes through Real Time Recording Rules evaluation. Based on that required Recording Variables are changed and other possible actions are taken (such as iteration is ignored, Recording Variable is created etc etc. —See actions of recording rules for more detail)
   g. Eventually processed information is passed to server component
2. Triggering Event (Alternative Flow to 1.d)
   a. If event is considered triggering system identifies the window/application under the event as follows
      i. If event is a Low Level mouse event—this will be GetWindowFromPoint
      ii. If event is a low level keyboard event—this will be GetActiveWindow (There might be exceptions for Keys switching between applications)
      iii. If event is MSAA event—the window will be deemed the one that sent the event
      iv. If event is APP specific—the window will be deemed the one that sent the event
   b. Based on that window the State Recording will be called, that will get the information (synchronization with prev State Recording) might be required. The event that triggered the State Event (previous step) will be placed in Triggering Event Variable. The timer for State Recording will be reset to now.
   c. Continue at 1.e

Interfaces for Recording Rules

As discussed previously Recording Rules are stored on per Process basis and copied together with process. In addition there should be a function enabling copying recording settings and recording rules to unrelated process (provided the Analyst has writing access to the target process).

The rules cannot be changed during recording. It has to be stopped and then rules can be changed.

Interface for adding/modifying/deleting rules should be GUI not scripting, except for the regular expression component in conditions and actions. Regular expression should follow java convention for simplicity.

Interface below should be treated as example only—actual interface to be worked on with designer. Resultant rules could be stored/processed in most efficient way.

Generally rules are evaluated independently. The only exception could be done for Image Analysis learning rules where different classification outcomes for the same screen could be combined into one evaluation algorithm (Ex: Neural network with multiple classification neurons).

During Rules establishment previous recording and its details should be generally visible so that user could copy paste certain Strings from recording into Rules.

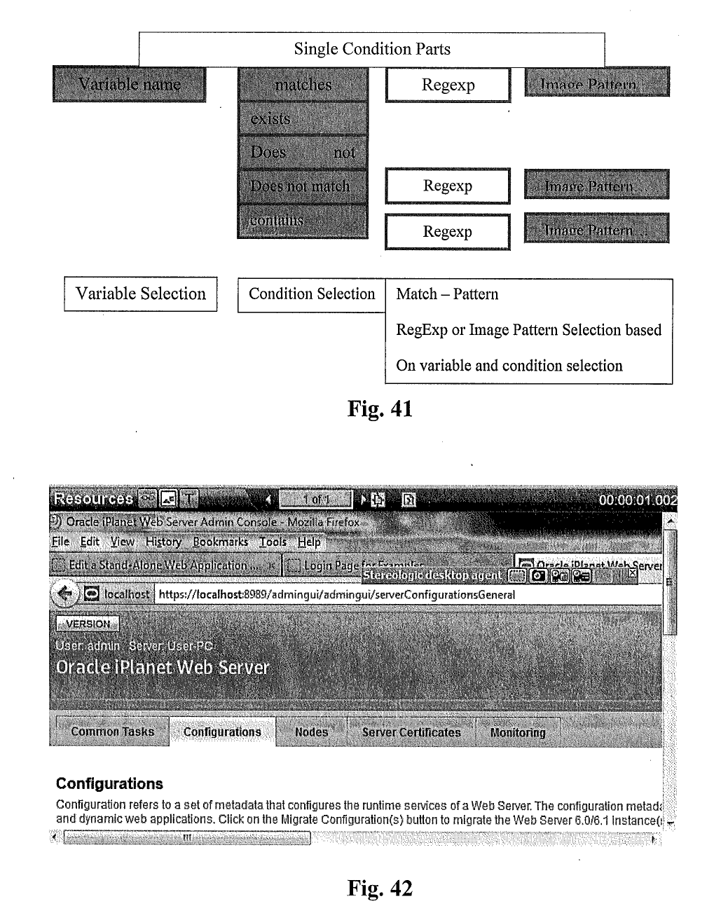

Conditions in one Rule form Boolean Algebra Expressions with AND OR NOT possibilities—FIG. 41

Special Variables—See Table Below.

Conditions Structure within the Rule—Conditions connected via Boolean algebra (if we find a good way to do parenthesis in interface then that too). Without parenthesis conditions can be reordered, but then the Boolean conditions between them will have to be reevaluated. By default all relationship between conditions is AND. For conditions involving image pattern a scaled down version of the pattern must be displayed within condition. By clicking on it the condition expands (See Image pattern selection Interface)

Actions—If combination of all conditions is satisfied according to Boolean algebra then set of actions will follow. Actions in a rule could be set/modified/reordered or removed from the rule. All actions will be done in order of their definition. If action cannot be done for whatever reason it is skipped. (For future we might have an action return variable). Certain Actions has parameters.

Kinds of Actions (other Actions may also be considered)

| Action | Explanation | Parameters |
|---|---|---|
| SET | Sets the value of non | 1. Variable to Set |
| | readonly variable to a new | 2. String value OR name |
| | value OR value of another | of another variable |
| | variable | |
| SET | Sets the value of non | 1. Variable to Set |
| REPLACING | readonly variable to a new | 2. String value OR name |
| | value OR value of another | of another variable |
| | variable and then applies | 3. Replacement Regexp. |
| | regexp replacement on the | |
| | result | |
| REPLACE | Sets the value of non | 1. Variable to Set |
| WITH | readonly variable to a value | 2. Replacement Regexp |
| | gone through Regexp. | |
| SPLIT | Starting from this Element | |
| FROM | split from previous. (IE | |
| PREVIOUS | movement forward is | |
| | orchestrated here). This sets | |
| | the move forward variable | |
| | to true and hence performs | |
| | an advance | |
| SPLIT | Same as SPLIT FROM | 1. Type of element |
| FROM | PREVIOUS but it also allows | (Activity, Start, |
| PREVIOUS | to change the type of the | End) |
| MAKE PREV | prev element. | |
| TYPE | | |
| SPLIT | Performs advance to next | |
| FROM | element right after this | |
| NEXT | screenshot | |
| IGNORE | Ignores Split even if | |
| SPLIT | automated state split | |
| | demands it. | |
| CHANGE | Changes the type of element | 1. Type of |
| ELEMENT | variable to one of the | Element |
| TYPE | following | (Activity, |
| TO | (START/END/ACTIVITY) | Start, End) |
| IGNORE | Ignores current screenshot | |
| | and all its variables all | |
| | together | |
| CREATE | Creates a variable with | 1. Default Value of |
| VARIABLE | Specified name if it did not | variable - optional - |
| | exist in recording priorly. | If not by default it is |
| | Once created the variable | set to “”; |
| | can be set and the setting | |
| | will be attached to all future | |
| | (and this screenshot)* | |

Motivation behind creation of variable is that certain data found in the variable (such as title) should be hidden (from title) but could be used for processing of other parts of the same process recorded at different time and different users. In other words this information allows to compile end-to-end picture from highly segmented processes

Example: Beginning of account opening assigns a task number visible in title. To make this element same with other starts of account opening the task number must be removed from there but this task number could be used to identify the continuation of account creation done by the back office in completely separate recording.

Conditions with image pattern recognition—These conditions allow validating whether a pattern is present on the screen or on a specific area on the screen. As such at time of condition creation or modification the user (analyst) should be able to reference one or more already recorded screenshots and pattern on them. During modification the analyst may select any other element—screenshots for referencing. The interface for each pattern selection should have the following
a. Movement between elements and screenshot (existing comparison mode or normal mode could be leveraged)
b. Screen area(s) selection—similar to paint selection feature (see Figure below) An optional feature (will be used in other functions as well) visually identifying the difference regions between current and previous screenshot and possibility to select a difference region as desired pattern—FIG. 42
c. A dialog with special conditions allowing to describe aspects of selected region.

Aspects of Selected Region Include:
a. Importance of details within selected area—When details are important matching/recognition should tolerate very little difference (details include for example text on a button). In opposite case details could be treated as noise and tiling (reduction of size of area) could be used before matching/recognition.
b. For condition based on Image.CLICKAREA variable there might be situation when in addition to pattern in click area, there are other patterns that lie in some direct relationship to the pattern in click area whose presence is important (see second figure). In such case both pattern for click area and related presence patterns must be identified and matching/recognition should find them in combination. —First find the click Pattern and then if found try to find the presence pattern based on geometric relationship between click area pattern and them.

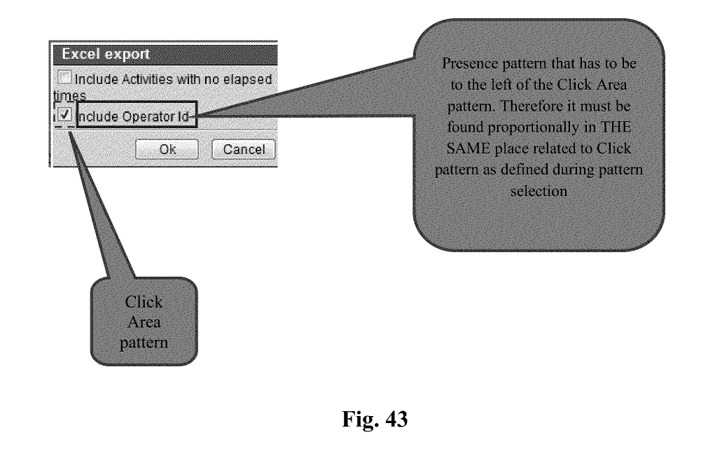

### Example FIG. 43

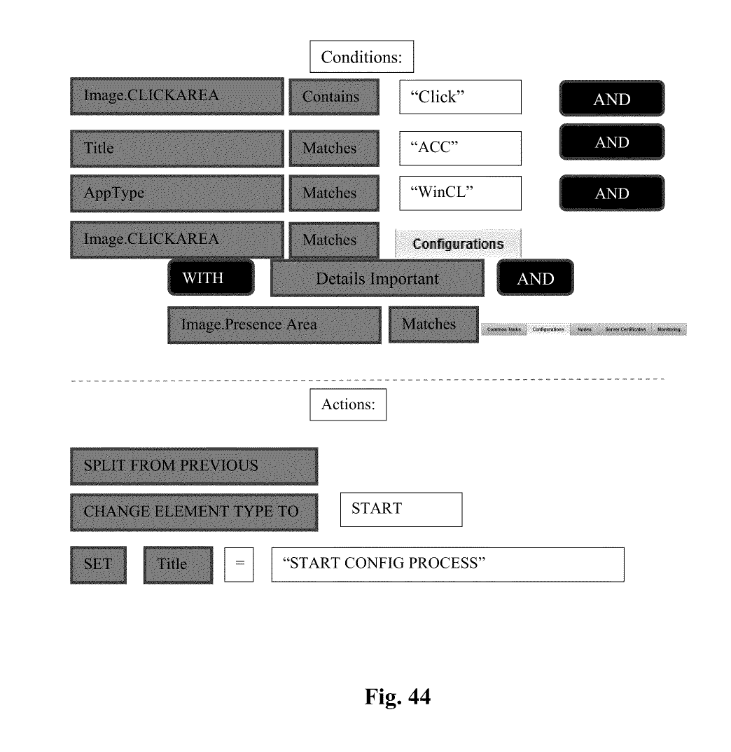

### Example of Rule Based on Image Analysis FIG. 44

Notes on Image Template Matching or recognition:

The algorithm should be scale invariant—at least for common scales (Ex: scale up 110:125:150:175:190:200; scale down: 90:75:50;

When details are not important use of down scaling/tiling is warranted to remove noise.

There are several algorithms for matching/recognition. This document presents one sample approach. In practice several algorithms may be tried and approach with best result should be selected. The test scenarios must involve variety of applications from mainframe to web images.

Sample Image Pattern Recognition Approach

This sample approach has the following settings
1. Find pattern in Image.CLICKAREA (meaning that the other part of the rule validates that the screen is of required type and CLICK (Left click) was a triggering event on it
2. No additional presence patterns required.
3. Details Are important

Stages—PipeLine
1. Identifying—the user sets up the rule using screen area selection interface. In addition the user may Identify same pattern on several other screens to help with training. Negative examples could also be identified.
2. Examples preparation—the system analyzes identified patterns and prepares positive and if required) negative examples. We make basic assumption that selected pattern does not change its aspect ratio. (Example: if identified pattern is a button sized X by Y the X/Y ratio remains the same on all scaled versions of the same pattern.) Both positive and negative examples are scaled required scales and scaled back to provide scaled negative examples. Additional care should be taken for partial appearances of the pattern.
3. Learning—This step is required only if the algorithm selected requires learning. In that case the examples are fed to train a machine learning algorithm (for example a classic back propagation neural net—although there might be more suitable examples out there). Some of the examples might be saved for a cross-validation set to select best hyper parameters for learning algorithm.
4. Rule Condition Analysis—happens when the screenshots are evaluated against rules. This happens in post analysis where selected screenshots/elements or whole recording is being fed through post analysis rules. Assuming that the first (variable based) part of the rules are evaluated to true a sliding window based approach is used (with, X/Y aspect ratio and actual sizes of scales as per examples) The sliding window is using step of 1-2 pixels and if different scale is used than the original each iteration of scaled window is scaled back to original X,Y proportion and fed to learning or matching algorithm. Because this specific example deals with Image.CLICKAREA the area of sliding is determined by possible normal and scaled boundaries of the pattern around click coordinates. In case there is partial feet of such boundaries additional step should be taken to process the non-fit areas to match the learning pattern.

### Example Details

### Examples Generation—Backpropagation Network

NOTE: This is example reference only—there may be better suited algorithms for this task or at least more optimized algorithms. (color distance based, Eulicidian distance near Neighbors etc). It is important that these techniques should be scale invariant, but should pay attention to details.
1. Positive Examples—The first positive example is the pattern itself. It is taken as base example and its size (X, Y) will be taken as base size for learning algorithm. Then positive example is transformed creating example as follows

Random addition of generic tooltip like images and parts of images on top of example. Generating tens to hundreds of positive examples.

If partial pattern strategy is to create a partial samples is used—generate positive samples by taking base example and cover parts of it with a black image from each of the 4 corners in steps of F pixels and from two sides until only about ¼ of example image is ready. This can produce 1000s or tens of 10000s of examples. (combinations of a and b are possible)

Certain gradients could be applied to generate positive examples

The base examples and all generated positive examples need to be scaled to the scaling sizes outlined and then scale back using randomly shuffled interpolation. All of these are positive examples.

Negative Examples

Take base example and rotate it along different axis (X, Y, Diagonal, half etc). Because for this sample details matter all of these will be considered negative examples (unless rotation gives out the same image)

Take random samples from the same image but outside of the identified area (same size).

Take any images identified by user as negative and scale them to X,Y size.

Rotate b, and c samples as in a.

As in 1.d perform forward and backward scaling to different set sizes and scale back using randomly shuffled interpolation.

All positive examples are labeled as 1 and all negative examples are labeled as 0;

Learning

Given the generated sizes a 3 layer neural network is built. Input Layer features X*Y*3+1 neurons, the hidden layer from ⅛ Input size +1 and output layer just one neuron (0 negative 1 positive). Sigmoid to be used as activation function, and regularized log based cost function will be used. (Hyperparameters area: learning rate alpha and regularization parameter lambda). Classic back propagation computation applies to compute gradient descent and weights update at each iteration.

Examples and their corresponding results for supervised learning are shuffled and some part of the examples is left for cross validation set.

Examples fed are all of size X*Y and each pixel is fed to three neurons in order row by row Red component—first neuron, Green component—second neuron, Blue component third neuron. Components are normalized to be within 0 to 1 range (0 . . . 0, 255 . . . 1) and for all positions to have a mean of zero. Initial values of hyper parameters are selected and used.

4 Runs of gradient decent are performed with different versions of alpha 400 iterations each (less if convergence occurred). (Alternative off the shelf minimization function can be used with certain number of iterations). Best run (minimal avg. cost) is taken.

Cross Validation test is run to select optimal level of the regularization parameter lambda. Learning parameters (weights) are saved

To speed up the process stochastic or mini batch gradient descent might be adopted.

Evaluation at Post Analysis

Because of Image Click area the sliding window is first set to a rectangle equal to base example size. The area in which the sliding window will operate (search area) is defined as full size of base pattern in any direction from the point of click. In case some image side is smaller than defined search area the area is supplemented with black color (0,0,0) inputs in these directions.

The sliding window moves inside the defined area with sliding step (ideally equal to 1 pixel). Each time the input is fed into the learned network (with prior normalization) and if output neuron is close to 1 this is considered a match.

If the match is not found, the sliding window and search area are then redefined to next scaled size (up first) and the process repeats, with the only exception that result of the window is first shrank or upscaled to the XY original size.

If no matches are found on all of the scaled sizes the algorithm returns false otherwise returns true.

Formal Definition of Sequence and Related Aspects

Pre Definitions

Element with no resources: Element hosting 0 recording resources. In general the resources mentioned in this document may pertain to recorded resources only.

Definition of uni-directional and non-alternative connections

A non-alternative uni-directional connection between elements A and B assumes directed full nameless (no label or empty label on the connector) connector(s) (short or long, one or multiple) from A to B, and no other outgoing full connections for A and no other Incoming full connections for B. A full connection is defined as a connector whose source and target are defined elements of any type. In addition uni-directional nature of the connection assumes A!=B. (A==B or a tight loop violates the uni-direction property)

Sub-Definition—Elemental Sub-Sequence.

Elemental sub-sequence is a uni-directionally and non-alternatively connected sequence of elements of allowed type (start, end, activity, sub-process) that have NO resources. A sub-sequence could be

Start-Terminal (ST-ELM)—

has a START element or ACTIVITY/SUB-PROCESS with no incoming connection rom which the sub-sequence starts, and terminates with allowable element with resources

End-Terminal(ED-ELM)—starts from some allowable element with resources and has an end element or ACTIVTY with no outgoing connections at its end.

Dual-Terminal (DT-ELM)—has a START element or ACTIVITY with no incoming connection from which the sub-sequence starts and terminates with an end element or ACTIVTY with no outgoing connections at its end. This is equivalent to full sequence of elements with NO resources.

Non-terminal (NT-ELM)—elemental sub-sequence that is connected to elements with resources from both ends.

Elemental sub-sequence elements can be viewed as elements hosting one continuous Ø resource (isFin=false), which may not be participating in any Asynch windows, and which result in 0 degree of fulfillment for any rule.

SL Sequence Definition

An SL sequence can be defined as a uni-directional non-circular sequence of orderly connected resources that has definite start, end and possibly a middle parts in the following order: Start(1)>middle(0 . . . 1)->End(1).

If for resource R, the immediately preceding resource is defined as parent P, all resources preceding R are defined as ancestors A, resource immediately following R is defined as Child C and all resources following R are defined as descendants D, then to be considered SL sequence:

Any resource R can have at most one Parent P and at most one child C. (no branching)

Resource X cannot belong to both Ancestors set A and Descendants set D for resource R at the same time(no looping)

Start of SL Sequence is defined as resource R with no parent P. This corresponds to first resource in element of any allowed type (start, end, activity, sub-process only) which has no incoming connection from another element, or any resource in the element which comes right after resource with isFin attribute set to true.

Elemental Start of SL Sequence—is defined as first element of Start-Terminal elemental sub-sequence that is terminated by the element to which Start of SL Sequence belongs or exactly the position of Start of SL Sequence if no such elemental sub-sequence exists.

Middle of SL Sequence is an ordered sequence of resources in which every resource R has exactly one preceding(parent) and one following resource(child), complies with overall definition of SL sequence, and R itself has isFin set to false. This definition covers the following situations and their combinations:

Resources Sequence Ordered within One Element

Resources from multiple elements connected in a uni-direct non alternative way. In this connection the last resource of the preceding element is considered to precede (be a parent of) the first resource of the succeeding (current element). Allowed element types are confined to start, end and activity (and sub-process).

Resources from multiple elements connected in a uni-direct non alternative way but connected through non-terminal elemental sub-sequences. As per definition, each elemental sub-sequence can be thought of as elements hosting 1 continuous Ø resource to comply with sequence definition.

Note: A non-alternative uni-directional connection between elements A and B assumes directed full nameless (no label or empty label on the connector) connector(s) (short or long, one or multiple) from A to B, and no other outgoing full connections for A and no other Incoming full connections for B. A full connection is defined as a connector whose source and target are defined elements of any type. In addition uni-directional nature of the connection assumes A!=B. (A==B or a tight loop violates the uni-direction property). Special case of connection occurs when last column element (Start or Activity) in row X, followed by element in the first column of row X+1 (Activty or End), and there is no other full nameless connection arising from [X][LastColumn]. This should be considered a uni-directional connection in the direction from row [X][Last Column] to [X+1][1].

End of SL sequence is the last resource in the sequence, i.e Resource R that has no child C. This corresponds to any last resource in the allowed element type, that has no further full outgoing connections (nameless or not) or to any resource in the element that has isFin set to true.

Elemental End of SL sequence—defined as last element of an End-Terminal elemental sub-sequence that is started by the End of SL sequence, or the End of SL sequence if no such elemental subsequence exists.

Elemental SL sequence (SLES)—SL sequence that can have elemental subsequence embedded into it, either at start, end or middle portions. This can be loosely defined as ST-ELM{0 . . . 1}>Start{0 . . . 1}> adhoc [NT-ELM{0 . . . ∞},middle{0 . . . ∞},]>End{0 . . . 1}>ED-ELM{0 . . . 1}

Empty Elemental SL sequence (EE Seq)—special case of Elemental SL sequences, that consists of one Dual-Terminal elemental sub-sequence (i.e sequence of elements with no resources at all)

The length of SL Sequence is measure by number of resources in the sequence. To be considered an SL

Extension of Definition—SLES SL Sequence and Process Split

Sequences can not only span rows but also processes via process split technology. In this case some sub-process element that is part of sequence by either having a resource or being part of elemental sub-sequence participating in a sequence and which has no full outgoing connections is automatically considered connected to the element at [1][1] of the sub process provided that the element in position [1][1]:

Has Type: end or activity (or sub-process)

Has no full incoming connections from anywhere

In this case R becomes the parent of resource M that is the first resource of the element at [1][1] of the sub-process.

Searching and Building SL Sequences as Input for Rules

The formal definition of SL sequence makes it hard to search for the sequences that are input for Rules Validation or Application. Therefore there are a number of search rules that relax the notion of the sequence and at the same time limit the number of sequences needed to be found and built. Rules Validation and application should be performed on Elemental SL Sequences (SLES) with special treatment of Elemental Sub-Sequences if they are embedded.

Sequences for Validation

Validation of a Rule (or part of thereof) can be performed on Single Resource, Source Element, or one group of Resources for source element, other element selection or top editor multiple selection. In each case the building of input SL sequence is as follows.

| Validation Type | Building Rules |
|---|---|
| One Resource | The Resource is pulled and becomes the input |
| | sequence |
| Source Element | The element is pulled, as though it has no |
| or any other | incoming or outgoing connections, and The |
| Single Selection | sequence(s) are built from resources that belong |
| Element. | to that element according to the sequence |
| | definition. (If no isFIn, this is just one sequence, |
| | otherwise isFin are the sequence demarkators) |
| | Special NOTE: if element has no resources - (EE- |
| | seq) the validation should return onegroup - |
| | with 0% degree of fulfillment. |
| Multiple- | For simplicity the search for sequences in a |
| Selection | multiple selection field will be severely |
| (need to | augmented: |
| decide as | 1. The search will only consider connections |
| task for | between elements that are fully within the |
| this release). | selection (all the rest omitted as nonexistent) |
| | 2. The search will look into first col/row of the |
| | selection (top/left corner), and must find an |
| | element there that can constitute a start of |
| | elemental SL sequence) |
| | 3. If it is true, the search should start building a |
| | sequence and does so until either the end of |
| | selection (bottom right corner) is reached or the |
| | SL Elemental sequence (SLES) cannot be build or |
| | ends prematurely (and another begins or not) |
| | 4. In case the end is reached and only one |
| | sequence is built send that for validation. |
| | 5. Otherwise output error message. |
| | Special NOTE: validation of elemental sub- |
| | sequences ranges if they are present in SLES: - |
| | each identifiable elemental sub-sequence |
| | should be treated as onegroup with 0% degree |
| | of fulfillment. This is true in case of Asynch too |
| | in the following way - one can imagine each |
| | elemental sub-sequence to have it's own unique |
| | id-string and 0% degree of fulfillment for any |
| | condition within sliding window constructed on |
| | that string. |
| | Since the presentation of validation results |
| | changes to include start and end of groups this |
| | should be easy to incorporate. |

Sequences for Highlight/Execute.

Find and Highlight/Execute implies selection of one or more processes as input. In case of multiple processes it is required to obtain a project map of the project in question and map the processes selection on it (As done for many exports). The first check before any execution begins, validates that the processes tree mapping conforms to general sequencing rules outlined below and establishes order at which processes will be fed to SL sequence build algorithm.

The initial project map rules are

All selected processes should form one or more unrelated uni-directional uni-connectional sequences.

Uni-directional sequence is a project map sub-tree where sequential rules apply

Incoming connections into first process of the sequence and outgoing connections for last process of the sequence are not considered. Otherwise:

Each process has at most one child and one parent (through a SINGLE connection)

Any process X cannot be both descendant and ancestor to some other process within the sequence

Unrelated implies that no process appears in two sequences at the same time.

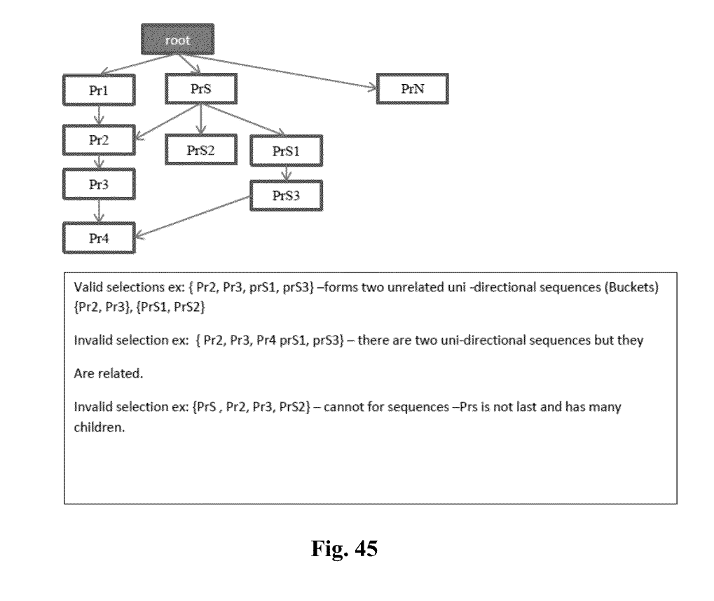

If mapping of the selected process group onto project map conforms to the rules then found process sequences serve as input buckets into SL sequence building mechanism. The buckets go into SL sequence building in the order defined by depth first search on their location in project map. FIG. 45

Once process sequences are identified and deemed valid, they can be fed into SL sequence building mechanisms as separate buckets. Naming and process settings of first process in each bucket are important for execution—Results presentation. (See Execution clarification section for details)

The processes in each bucket are then traversed, to build SLES SL Sequences that will be used for rules applications. In the first process of the bucket this process goes according to the following rules

For execute/highlight isFin attributes are ignored (as though they are all false). Alternative behavior report error on process containing isFin=true;

Process space is scanned from right to left and then top to bottom, until resource corresponding to start of the SLES sequence is found.

If no SLES sequence is found, the algorithm should proceed to next process in the bucket.

If start is found, the algorithm should scan this sequence in until one of the following:

There is an error—this is not a sequence according to SLES sequence definition. Process is discarded and logged all together, and we proceed to next process—alternative more complex behavior try to find next sequence from graph—next release) (If sequence spanned some previous processes—all of them will report error). The algorithm then goes to search in next available process in the bucket.

Sequence is fully ended and registered within a process—SLES SL sequence is built and knowledge of the process and process bucket from which it was built is saved. The algorithm then proceeds with SLES sequence search start in the next cell after the end of sequence (left->right then top->to bottom approach)

The sequence is properly augmented with sub-process element—In this case the algorithm tries to connect last sub-process element with first element at [1][1] of sub process (according to SLES SL Sequence definition extension) and that sub process is also part of the bucket. If this is done successfully, the sequence continues to be built in the sub-process, and the algorithm never returns to this process. If for whatever reason the connection is not successful, then the following actions are taken
i. The SLES SL sequence is considered to be ended in the parent process.
ii. The search algorithm will continue in the sub-process and never return to the parent process.

If algorithm finished searching in some process in the bucket and there is no connection to next process in the bucket, then the algorithm should finalize the sequence at the end if it has one going (no—if not) and proceed to next process in the bucket.

Once one original bucket is processed the algorithm is free to go to next bucket and so on.

IMPORTANT NOTE: The actual order of building SLES SL sequences, executing, building results etc—could be different from described here if the result achieved is logically the same.

Highlight clarifications

When working with results of highlight—the real importance are the found control points themselves and their relations to source processes. So there is no real need for bucket information once sequences are built.

Sub-Elemental Highlight Clarification

If highlight of certain found is cut by elemental subsequence, multiple starts/ends of the group should be used. (This is true for asynch situations as well)

Execution Clarifications and Changes—Result Sequences

The execution now only works by recreating and rewriting the sequences in new processes or even in new project. In both cases the following applies

The sequences are completely recreated with newly created control points. Since part of execution could create new sequences by creating start/end elements the output sequences will not be equal to input sequences. However even if one input sequences is now split into several output sequences their bucket domain remains the same.

By default newly created process name is inherited from the combination of the ethalon process name, and current sequence bucket name (Derived from first source process in the bucket) separated by underscore. This means that sequences from separate buckets will end up in separate processes (a sequence with new bucket domain different from previous bucket domain with start in new process).

A more desired behavior is to allow the user to enter an execution phrase (maximum 30 chars) before the execution, and then the process name become combination of this phrase and current sequence bucket name separated by underscore. Examples:

a. CrdApply_barryrec;

b. CrdApply_montyrec.

Every result sequences is started from new line (first column, first available row of the process), and continues through until the end or process split. Newly created process have column count of 20, so when line reaches 20, the carryover goes to next row.

Process split should occur according to process split settings of the first source process in the bucket from which the result sequences are formed. The process split should be fully governed by the process split rules except the following:

Do not split over found winning control point (Requirement described in previous documents). In case process split has to be performed in the middle of control point, wait until the control point is full written into process and then do split in between control points.

Respective Examples of Process Split Names CrdApply_Barryrec_X; CrdApply_Montyrec_X

Treatment of elemental-subsequences. Elemental sub-sequences should be treated as islands where the rules give 0% degree of fulfillment and each island has own unique idString. This enables to make sure that no rules are fulfilled on the elemental-subsequence but Asynch windows are formed correctly and control points around the elemental subsequences are correctly recognized. Once control points are found the following should happen to the elemental subsequence:

The elements of the sub-sequence are always rewritten into resultant sequence as is with exception of sub-process elements changed to activities as required.

If elemental sub-sequence “cuts” through range fulfilling some rule and recognizing control point (CP) defined by Asynch window, the result should be presented just as though some other elements with resources with different idString cut through that range—One result is presented with multiple start and end locations. Two separate states should be created.

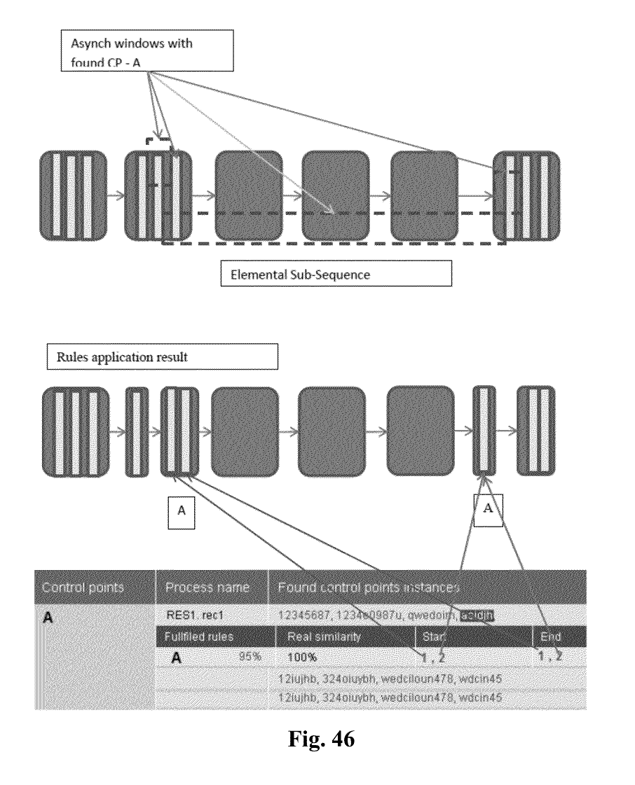

If elemental sub-sequence “cuts” through a fulfilling range but without common asynch window on both sides of range, two control points should be presented, exactly as if elements with resources but without rule fulfillment would cut in. Two separate states should be created. FIG. 46

Preferred and exemplary embodiments of this invention are described herein. Variations of those embodiments may become apparent to those of ordinary skill in the art upon reading the foregoing description. It is expected that skilled persons will employ such variations as appropriate, and it is expected that the invention may be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Without limiting the generality of the foregoing statement, some specific examples of possible variations may include the following, though others may be apparent to those knowledgeable in the field of the invention:

Further variations may be apparent or become apparent to those knowledgeable in the field of the invention, and are within the scope of the invention as defined by the claims which follow.

1. A method for performance measurement comprising:
determining at least a first significant point and a second significant point based on baseline patterns of a business operation;
detecting at least one combination of parameters characterizing the at least two significant points;
determining recognized patterns based on the first and second significant points;
measuring a time between a first significant point and a second significant point of a recognized pattern; and
generating at least one performance measurement based on the measured time.

2. The method of claim 1, further comprising:
monitoring a plurality of users performing the business operation;
determining if the first significant point and the second signification point of the recognized pattern correspond to the business operation for each user of the plurality of users; and
if the first significant point and the second significant point correspond, measuring each user's performance to generate the at least one performance measurement.

3. The method of claim 1 wherein the at least one parameters comprise screen layout, data on a screen, user events, images, and related elements.

4. The method of claim 1 wherein a plurality of parameters is detected to characterize the at least two significant points.

8. The method of claim 1 wherein the at least one performance measurement comprises: number of processes completed by a user; average time per process, user time per process and deviation of user performance.

6. The method of claim 1 wherein the monitoring of the plurality of users performing business operations is monitored in real time.

7. The method of claim 1 further comprising:
storing the monitoring of the each of the plurality of users performing business operations as a stored performance; and
performing analysis related to the at least one performance measurement based on the stored performance.

8. The method of claim 1 further comprising: providing suggested changes to the business operations based on the at least one performance measurement.

9. The method of claim 1 further comprising: analysis of delays and detection of actual activities causing them based on comparison with the baseline pattern activities and providing suggested changes to the business operations based on the at least one performance measurement.

10. A system for performance measurement comprising:
a significant point module configured to determine at least a first significant point and a second significant point based on baseline patterns;
a parameter module configured to detect parameters characterizing the at least two significant points;
a parameter pattern module configured to determine recognized patterns based on the key parameters;
a timer module configured to measure a time between the first significant point and the second significant point of a recognized pattern; and
a reporting module configured to generate a performance measurement based on the measured time.
